(19) United States
(12) Patent Application Publication
(10) Pub. No.: US 2026/0170539 A1
(43) Pub. Date: Jun. 18, 2026

(54) METHOD AND SYSTEM FOR RATING VENDOR AND PRODUCT CYBERSECURITY

(71) Applicant: ObjectSecurity LLC

(72) Inventors: Ulrich LANG, San Diego, CA (US); Trevor THOMAS, Verona, WI (US); Jason KRAMER, Studio City, CA (US)

(73) Assignee: ObjectSecurity LLC, (US)

(21) Appl. No.: 19/418,532

(22) Filed: Dec. 12, 2025

Related U.S. Application Data
(60) Provisional application No. 63/733,352, filed on Dec. 12, 2024.

(51) Int. Cl. G06Q 30/0282; G06F 21/57

(52) U.S. Cl. CPC G06Q 30/0282; G06F 21/577; G06F 2221/034

(57) ABSTRACT

Method and system for rating the cybersecurity of vendors and products, including loading input data from data sources pertaining to vendor or product cybersecurity; selecting sub-rating calculation templates from a preconfigured set of sub-rating calculation templates corresponding to the input data; calculating vendor or product sub-rating scores by applying sub-rating calculation templates to the input data; generating vendor or product primary rating scores by applying an aggregation template to the vendor or product sub-rating scores; storing in memory storage the vendor or product primary rating scores, the vendor or product sub-rating scores, and the input data; ranking the vendor or product primary rating scores among other vendor or product primary rating scores using a ranking strategy; and distributing the vendor or product rating results to data sinks over a computer network or displaying vendor or product rating results in a user interface.

This application claims priority to U.S. Provisional Application No. 63/733,352 entitled “Method and System for Rating Vendor and Product Cybersecurity”, which was filed on Dec. 12, 2024, and which is incorporated herein by reference.

This invention was made with government support under 70NANB25H142 awarded by the National Institute of Standards and Technology (NIST). The government has certain rights in the invention.

### BACKGROUND OF THE INVENTION

### 1. Field of the Invention

The present invention generally relates to systems and methods for analyzing diverse data sources relevant to cybersecurity compliance, privacy, etc., including, but not limited to, product security, vendor security, and related domains. More specifically, an example of the invention pertains to the automated aggregation and analysis of at least one data source, including but not limited to the National Vulnerability Database (NVD), the Known Exploited Vulnerabilities (KEV) Catalog, product manuals, online security forums, vendor self-attestation data, etc., to compute a security rating score for vendors and their products. An example of the rating system and method enables, for example (but not limited to), buyers to evaluate and select more secure products and vendors, thereby encouraging vendors to improve the cybersecurity posture of both their products and organizational practices.

### 2. Description of the Related Art

Rating vendor and product cybersecurity refers to the process of collecting and analyzing qualitative and/or quantitative metrics pertaining to a vendor and its products to assess their cybersecurity posture. Such evaluations may serve one or more purposes, including but not limited to improving organizational and product security, supporting informed decision-making, reducing risk exposure, and providing justification for procurement or investment activities, etc. The ability to rate vendor and product cybersecurity is significant to technology vendors, customers, and government entities alike, each deriving distinct benefits aligned with their respective objectives.

Conventional approaches to rating vendor and product cybersecurity involve both manual and automated techniques, supported by select tools and technologies. In general, there exist three notable distinct conventional approaches to consider, which are organizational cybersecurity compliance frameworks, secure product development frameworks, and commercial tools aimed at automated security-related analyses (e.g., SBOM generators, network monitoring software, compliance assistance systems, etc.).

Conventional organizational cybersecurity compliance frameworks, such as NIST Special Publications 800-53, 800-82, and 800-171, provide comprehensive guidance for establishing and maintaining organizational cybersecurity controls, resulting in a primarily qualitative evaluation of a vendor's current cybersecurity posture. These frameworks assist enterprises in implementing secure operational environments, managing user access, and safeguarding sensitive information across both Information Technology (IT) and Operational Technology (OT) infrastructures. However, such frameworks are primarily oriented toward organizational and procedural security rather than the intrinsic cybersecurity characteristics of the products and systems developed, manufactured, or distributed by those organizations. Consequently, the relationship between organizational compliance and actual product-level security outcomes remains weak, indirect, and insufficiently characterized.

Frameworks designed to address product development security, such as NIST's Secure Software Development Framework (SSDF) and the Federal Trade Commission's Careful Connections guidance, offer high-level recommendations for integrating security practices into the software development lifecycle. Nonetheless, these frameworks lack mechanisms for quantifying the degree to which prescribed controls are effectively implemented. Ensuring compliance with these frameworks is often labor-intensive and prone to human error, requiring manual audits and document-heavy reviews. Moreover, since compliance framework assessments are typically performed periodically, their results can become outdated. They also do not translate implementation performance into standardized, comparative metrics that can inform procurement decisions, supplier risk assessments, or market-based product evaluations. As a result, purchasers and operators are deprived of objective, data-driven insight into product-specific cybersecurity risks.

A variety of commercial tools have emerged to support vendors in improving product security outcomes through vulnerability identification, compliance assistance, and audit facilitation. For example, some tools provide continuous vulnerability scanning and risk analytics, while others offer compliance tracking and security posture management capabilities. Although these tools can help identify and remediate vulnerabilities, they do not address the fundamental economic and behavioral barrier—namely, the absence of sufficient incentives for vendors to adopt proactive security improvement measures. In the absence of market-driven or regulatory incentives, many vendors limit security investments to the minimum necessary for compliance. Furthermore, the cost and complexity of these tools often restrict adoption to larger enterprises, leaving small- and medium-sized vendors with limited access to effective product security enhancement resources.

In the Operational Technology and Industrial Control Systems (OT/ICS) sector and beyond, Software Bill of Materials (SBOM) tools assist end-users in identifying vulnerabilities in deployed products. Unlike Information Technology (IT) systems, OT/ICS products frequently have extended device lifecycles, leading to issues such as vendors that may no longer exist, products that are no longer supported, infrequent patches, and the need for ongoing analyses when Software Bill of Materials (SBOM) standards evolve. While SBOM tools provide visibility into software components, they place the burden of product security management on operators and asset owners rather than on vendors. This decentralized approach is inefficient and economically impractical, as a single product deployed across thousands of environments would necessitate an equivalent number of redundant vulnerability assessments. A more effective and scalable approach is to perform comprehensive product security evaluation and assurance at the manufacturing level prior to distribution and deployment.

### SUMMARY OF THE INVENTION

Herein are some examples of how the invention may be implemented. Note this list is not exhaustive, and the invention may be created in some other manner similar in function, but not within the example's exact specification. It is therefore an object of the invention to provide one or more of the following:
automated calculation and/or generation of rating(s) and/or score(s) representing a technology vendor's effectiveness in implementing cybersecurity practices. Such calculations may be performed using formalized and/or mathematical models to assess factors including, but not limited to, the vendor's level of compliance with applicable cybersecurity standards and/or frameworks, the security of the vendor's product development and/or deployment process(es), documentation and/or disclosure of known vulnerabilities in the vendor's product(s), the vendor's engagement with the broader security community and/or relevant government entities (e.g., NIST, CISA, etc.), the historical likelihood and/or frequency of exploitation of the vendor's product(s), the timeliness and/or quality of the vendor's security-related updates and/or patches, the severity and/or recurrence of vulnerabilities identified in the vendor's product(s), the inclusion and/or omission of critical security configuration features within those products (including, but not limited to, use of multi-factor authentication, avoidance of default credentials, and/or implementation of encrypted communication channels), etc. An intent of such calculations may for example be that demonstrably positive, secure, and/or safety-conscious vendor behaviors result in improved rating(s), while negligent, insecure, and/or high-risk practices adversely affect the vendor's rating(s).
comparative cybersecurity metrics, scores, ratings, and/or rankings for vendors and their respective product(s). Such comparative assessments may assist customers, procurement officers, and/or other decision-makers in identifying and/or selecting the most suitable vendor(s) and/or product(s) within a given category and/or class based on cybersecurity performance. By enabling objective comparison, the disclosed method may for example facilitate more informed procurement decisions and/or may encourage customers to modify and/or optimize their vendor selection(s) in favor of those demonstrating superior cybersecurity practices.
mechanism to incentivize technology vendors—including, but not limited to, Operational Technology (OT) manufacturers, Information Technology (IT) manufacturers, and/or software/hardware vendors in general—to proactively enhance their cybersecurity posture and/or the security of their product(s). Such incentivization may for example include, but is not limited to, creating a centralized database of vendor and/or product risk, promoting the adoption and/or use of diverse cybersecurity tools and/or techniques to cover one or more vectors, encouraging collaboration between vendors and researchers, adding security requirements to procurement processes, promoting the detection, disclosure, and/or remediation of vulnerabilities within released devices, software, hardware, other technology products, and/or associated organizational processes. Such incentivization may for example result in a measurable, sustained, and or otherwise meaningful improvement to national security and/or public safety. It may include a gamification engine that includes, but is not limited to, tracking points per product and/or vendor, challenges, certificates, virtual currency, leaderboards, and/or rewards. It may encourage users to adopt better security practices.
access to some or all of the calculated vendor cybersecurity metrics, scores, ratings, and/or rankings through one or more available interfaces, for example including, but not limited to, a website, web-based application programming interface (API), embeddable and/or integrable widgets, open-source scripts and/or software tools, publications such as blog posts, and/or other digital and/or written materials.
a distinction between a primary rating associated with a vendor and/or product and one or more constituent sub-rating(s) whose aggregation produces the primary rating. The aggregation of such sub-ratings may be performed using, but not limited to, a weighted-average model, an unweighted-average model, machine learning-based techniques (for example, regression analysis, clustering, neural network models, etc.), and/or other suitable statistical or computational methodologies. The set of sub-ratings selected for aggregation may be determined automatically and/or may be manually specified through user input.
one or more sub-ratings configured to evaluate vendors and/or products based on their likelihood of exploitation by a malicious actor and/or entity. Such sub-ratings may incorporate and/or analyze data sources including, but not limited to, Common Vulnerabilities and Exposures (CVEs), Known Exploited Vulnerabilities (KEVs), related vulnerability intelligence repositories, etc.
one or more sub-ratings configured to assess the quality and effectiveness of a vendor's and/or product's vulnerability remediation strategy. These sub-ratings may incorporate and analyze data sources such as, but not limited to, CVEs, Common Platform Enumerations (CPEs), product release notes, vendor advisories, technical blog publications, etc.
one or more sub-ratings configured to evaluate vendors and/or products based on the severity and/or frequency of their historical vulnerabilities, incorporating and/or analyzing data sources such as for example CVEs, cybersecurity news reports, financial disclosures, etc.
one or more sub-ratings configured to assess a vendor's and/or product's ability to communicate information regarding security incidents and/or vulnerabilities preferably, for example in a clear, transparent, and/or technically accurate manner. These sub-ratings may utilize and/or analyze data sources for example including, but not limited to, CVEs, CPEs, Vulnerability Disclosure Policy (VDP) data, bug bounty program data, etc.
one or more sub-ratings configured to evaluate vendors and/or products based on their inclusion of secure features such as for example configuration options (e.g., multi-factor authentication (MFA), encryption of communications, etc.) and/or avoidance of insecure defaults (e.g., use of default or weak passwords, etc.).
one or more sub-ratings aligned with the objectives of the Cybersecurity and Infrastructure Security Agency (CISA)'s Secure-by-Design pledge, including, for example but not limited to, assessment of: adoption of MFA, reduction in the use of default passwords, reduction in classes of known vulnerabilities, increased customer adoption of security patches, publication and/or maintenance of a VDP, transparency and/or timeliness in vulnerability reporting (including accurate CPE and/or Common Weakness Enumeration (CWE) records), implementation of improved mechanisms for detecting potential product compromises, etc.
a generalized method for calculating a sub-rating for a vendor and/or product, comprising the augmentation of product vulnerability data (e.g., NVD data, CVEs, CPEs, VulnDB data, ExploitDB data, OSV data, vendor advisories, etc.) with one or more additional data sources to generate a baseline sub-rating. A baseline sub-rating may for example be normalized using vendor-specific metadata, including, but not limited to, vendor size, vendor self-attestation data, and/or related contextual factors. Such normalization may ensure that vendors of varying sizes, market exposure levels, and other distinguishing and/or outlying characteristics are evaluated fairly and are not unduly advantaged and/or penalized by the rating methodology.
a method for providing constructive and/or actionable feedback to vendors regarding methods by which they may improve their primary cybersecurity rating and/or any number of constituent sub-ratings. Such feedback may be delivered through any number of mechanisms, including, but not limited to, information presented on an accessible webpage, individualized automated email communications, sub-rating-specific recommendations, and/or integrations with an advisory Large Language Model (LLM)-based chatbot system, etc.
functionality enabling visualization of changes in vendor and/or product cybersecurity ratings and/or sub-ratings over time. Such functionality may include, but is not limited to, user interface components and/or data visualization tools such as date, month, and/or year range selectors and/or sliders; time-series charts and/or line graphs; and/or dynamically re-rankable leaderboards displaying vendors and/or products according to their current and/or historical rankings, etc.
functionality enabling the selection, refinement, and/or filtering of vendors and/or products based on technology type and/or product category, including, but not limited to, embedded systems, operating systems, web applications, medical devices, and/or related software, etc. Such selection, refinement, and/or filtering may dynamically alter visual representations and/or calculated rating and/or ranking outcomes, etc., for example, by restricting the visualization and/or computation to a specific subset of vendors and/or products.
functionality enabling the selection, refinement, filtering, and/or sorting of vendors and/or products based on one or more sub-ratings, including any of the sub-ratings referenced herein and/or additional sub-ratings not explicitly described in this document. Such selection, refinement, filtering, and/or sorting may dynamically modify visual representations and/or calculated rating and ranking outcomes, for example, by constraining the visualization and/or computation to a specified subset of sub-ratings.
automated web-scraping of data sources relevant to the vendor and/or product rating system, performed on a frequent, scheduled, periodic, and/or recurring basis, such that all or most vendor and/or product ratings and sub-ratings are continuously informed by the most recent iteration of all or most relevant data sources. The data collected through such web-scraping processes may originate primarily from sources (including but not limited to the NVD, product manuals, blog posts, etc.) and/or may be normalized, transformed, and/or pre-processed etc. prior to being stored within one or more database tables internal to the system.
an accessible network-based application programming interface (API) (e.g., HTTP, RESTful, JSON, and/or equivalent) configured to respond to client-supplied query parameters and/or arguments. Such parameters and/or arguments may include, but are not limited to, filtering, sorting, searching, and/or indexing operations applied to vendors, products, and/or their associated ratings and/or sub-ratings etc.
an accessible, web-or browser-based user interface (UI) configured to perform searching, sorting, filtering, and/or indexing operations on vendors, products, and their associated ratings and/or sub-ratings. Such operations may be executed through a variety of interactive UI components, including, but not limited to, buttons, search bars, scrollable views, sliders, checkboxes, and/or radio buttons etc. The UI may provide access to one or more dedicated webpages for each rated and/or ranked vendor. These webpages may include, but are not limited to, UI elements displaying vendor identifiers such as names and/or logos, primary ratings, sub-ratings, product categories, and/or accompanying descriptive and/or explanatory information regarding the respective ratings and/or sub-ratings etc.
integrations of vendor and/or product ratings with third-party software, systems, and/or platforms, including, but not limited to, integration with search engines, browser extensions, and/or online marketplaces/storefronts etc. Such integrations may enable vendor and/or product ratings to be displayed and/or accessible at the moment of procurement and/or purchase.
a vendor self-attestation system, framework and/or interface through which vendors may submit data including, but not limited to, updated product documentation, software patch information, evidence of cybersecurity compliance, and/or other relevant remediation materials etc. Such data may be made accessible and/or utilized to update and/or adjust the vendor's corresponding ratings and/or sub-ratings in accordance with the most current and/or accurate cybersecurity posture, and/or to correct any potential inaccuracies in the rating calculations associated with the vendor and/or its products.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description. For example, singular or plural use of terms are illustrative only and may include zero, one, or multiple; the use of “may” signifies options; modules, steps and stages can be reordered, present/absent, single, or multiple etc.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 depicts some of the vendor cybersecurity rating system's example use cases and how they may impact vendors and their customers;

FIG. 2. depicts a system architecture diagram wherein example data sources may be used to produce and/or prepare vendor cybersecurity ratings;

FIG. 3. depicts a functional diagram for calculating and/or aggregating example sub-ratings into primary vendor rating(s);

FIG. 4. depicts a functional diagram for calculating an example exploitability sub-rating;

FIG. 5. depicts a functional diagram for calculating an example remediability sub-rating;

FIG. 6. depicts a functional diagram for calculating an example severity sub-rating;

FIG. 7. depicts a functional diagram for calculating an example explainability sub-rating;

FIG. 8. depicts a functional diagram for calculating an example configurability sub-rating;

FIG. 9. depicts a functional diagram for calculating an example abstract and/or generic sub-rating;

FIG. 10. depicts an example UI for viewing, filtering, searching, and/or sorting vendors based upon their ratings and/or sub-ratings;

FIG. 11. depicts an example UI for viewing the rating of a distinct vendor and other vendor-specific information, including the vendor's sub-ratings;

FIG. 12. depicts an example UI for viewing the explanation of the rating and/or sub-rating calculation(s);

FIG. 13. depicts an example UX flowchart wherein a user may alternate between viewing vendor ranking, vendor rating, and rating explanation;

### DETAILED DESCRIPTION

### Terminology

Baseline Sub-Rating—A preliminary and/or foundational sub-rating that may be generated through initial data analysis. It may be derived from, but is not limited to, the synthesis of raw product vulnerability field(s) with supplemental metrics, prior to vendor normalization and/or other contextual adjustment, etc.
Bug-Bounty Program Data—Data obtained from coordinated vulnerability disclosure and/or incentive-based programs in which independent security researchers identify and/or report product vulnerabilities to vendors in exchange for recognition and/or reward.
Common Platform Enumeration (CPEs)—Standardized identifiers that describe software, hardware, and/or firmware platforms, typically used for vulnerability tracking, correlation, and/or classification.
Common Vulnerabilities and Exposures (CVEs)—Publicly disclosed cybersecurity vulnerabilities cataloged and/or maintained under the CVE system, identifying specific weaknesses in software and/or hardware components.
Common Vulnerability Scoring System (CVSS)—A standardized framework used to assign numerical severity scores to CVEs, indicating potential impact and/or exploitability.
Configurability Sub-Rating—A sub-rating measuring, calculating, and/or scoring metrics pertaining to, but not limited to, the degree to which a product and/or vendor allows secure configuration by end-users, including the presence of security options (e.g., multi-factor authentication, encryption, etc.) and/or the absence of insecure defaults (e.g., hardcoded and/or default passwords, etc.).
Customer(s) and/or Buyer(s)—Entities including, but not limited to, individuals, organizations, and/or government agencies, that procure and/or evaluate technology products and/or vendor services based in part on cybersecurity rating data.
Constituent Data Storage—A structured data repository, and/or collection of repositories, containing aggregated information ingested from one or more public and/or vendor-provided data sources. Such storage may be implemented using one or more persistent storage mechanisms, including relational databases, document-oriented databases, vector databases, and/or file systems, and may serve as the foundational dataset upon which rating and/or sub-rating calculations may be performed.
Cybersecurity Compliance Framework(s)—Industry-standard, government-issued or other standards, guidelines, and/or best practices outlining controls and/or best practices for securing information systems and/or operations (e.g., NIST SP 800-53, ISO 27001, etc.).
Cybersecurity Practices and/or Cybersecurity Posture—Security-related behaviors, policies, configurations, and/or technical implementations that define an organization's or product's overall resilience against cyber threats.
Cybersecurity Ranking and/or just “Ranking”—A relative ordering of vendors and/or products based on comparative analysis of calculated cybersecurity ratings and/or sub-ratings.
Cybersecurity Rating and/or Primary Rating and/or just “Rating”—The aggregate and/or overall score representing the cybersecurity performance of a vendor and/or product, derived from the weighted and/or otherwise aggregated combination of one or more sub-ratings.
Cybersecurity Sub-Rating and/or just “Sub-Rating”—A component rating representing performance in a specific cybersecurity domain and/or metric category (e.g., exploitability, configurability, severity, remediability, etc.).
Default Passwords—Predefined authentication credentials embedded in software and/or hardware at the time of distribution that, if unchanged, may present a cybersecurity risk.
Encrypted Communications—Communication channels secured through cryptographic protocols (e.g., TLS, SSH, etc.) to ensure confidentiality, integrity, and/or authenticity of transmitted data.
Explainability Sub-Rating—A sub-rating measuring, calculating, and/or scoring metrics pertaining to, but not limited to, a vendor's ability to communicate security incidents, vulnerabilities, and/or mitigations preferably, for example clearly and/or accurately, to customers and/or the public.
Exploitability Sub-Rating—A sub-rating measuring, calculating, and/or scoring metrics pertaining to, but not limited to, the likelihood that vulnerabilities associated with a vendor and/or product could be successfully exploited by malicious actors.
Financial Data—Data relating to, but not limited to, a vendor's economic performance, such as market capitalization, financial losses due to security breaches, and/or the financial impact of cybersecurity incidents.
Flesch-Kincaid Scoring—A readability assessment method that quantifies the linguistic complexity of a body of text using mathematical formulas based on sentence length and/or word syllable count. The Flesch-Kincaid Reading Ease and Grade Level scores are widely recognized metrics for evaluating how easily written content can be understood by an average reader. Higher scores generally indicate simpler, more accessible text, while lower scores correspond to increased linguistic complexity. Within the context of this invention, Flesch-Kincaid scoring may be used to evaluate and/or normalize textual data sources (e.g., CVE/CPE descriptions, vendor documentation, security advisories, vulnerability reports, etc.) to assess clarity, readability, and/or communication quality.
Generic Sub-Rating and/or Abstract-Rating—A generalized and/or adaptable sub-rating framework that may be applied to one or more contexts, vendor classes, and/or product types, which is not limited to any specific dataset and/or metric domain. For example, it may involve the synthesis of raw product vulnerability field(s) with supplemental metrics to produce one or more baseline sub-rating(s), which, after vendor normalization, produces one or more sub-rating(s).
Known Exploited Vulnerabilities (KEVs)—A catalog of vulnerabilities that have been observed as actively exploited in the wild, typically maintained by authoritative entities such as the Cybersecurity and Infrastructure Security Agency (CISA).
Large Language Model (LLM)—A machine learning model trained on large textual datasets and capable of performing natural language processing tasks such as, but not limited to, summarization, question answering, and advisory guidance; with a particular focus on, at least, in the context of the invention, providing vendors with rating and/or sub-rating improvement advice.
Multi-Factor Authentication (MFA)—An authentication mechanism requiring two or more verification factors to enhance security beyond single-factor methods such as passwords alone.
National Vulnerability Database (NVD) Data—Structured cybersecurity vulnerability data maintained by the U.S. National Institute of Standards and Technology (NIST) as part of the NVD system. For example, this data may consist of CVEs and/or CPEs.
News Articles—Publicly accessible media publications containing information that may be relevant to, although, not limited to, cybersecurity incidents, vulnerabilities, and/or vendor performance.
Product Manuals—Official, informal and/or semi-official documentation that may be provided by vendors describing product-related details including, but not limited to, operations, configuration, features, and/or maintenance, which may contain information relevant to security posture evaluation.
Product Vulnerability Data—Structured cybersecurity data describing known or potential vulnerabilities associated with specific products, including product versions, affected components, and the technical nature of each vulnerability. Examples of product vulnerability data may include, but are not limited to, National Vulnerability Database (NVD) data, Common Vulnerabilities and Exposures (CVEs), Common Platform Enumerations (CPEs), VulnDB data, ExploitDB data, Open Source Vulnerability (OSV) data, and/or vendor-issued advisories.
Product(s)—Virtual or physical items comprising software, hardware, and/or hybrid technology offerings developed, manufactured, and/or distributed by a vendor.
User Interface/User Experience (UI/UX)—The (e.g., web-based) interface and/or user experience component(s) through which users may perform actions including, but not limited to, viewing, querying, and/or otherwise interacting with vendor and/or product cybersecurity ratings.
Purchase Decisions—The process(es) by which customers and/or buyers select products and/or vendors to purchase, potentially, although not necessarily, informed by cybersecurity ratings, rankings, and/or other related risk data.
Raw Product Vulnerability Field(s)—Unprocessed and/or unnormalized data fields that may be extracted from, for example, one or more Common Vulnerabilities and Exposures (CVE), Common Platform Enumeration (CPE), VulnDB data, ExploitDB data, OSV data, and/or vendor-issued advisory. These fields may be used in conjunction with one or more supplemental metrics to produce one or more baseline sub-rating(s).
Remediability Sub-Rating—A sub-rating measuring, calculating, and/or scoring metrics pertaining to, but not limited to, a vendor's responsiveness and/or effectiveness in addressing and/or resolving identified vulnerabilities for example through timely patches and/or updates.
Reproducibility Engine—Software and/or hardware components configured to process, analyze, expose, document, and/or visualize the end-to-end process by which vendor and/or product cybersecurity ratings and/or sub-ratings are derived, which may provide transparency and/or auditability to users.
Secure Product Development Framework(s)—Structured methodologies and/or standards, including but not limited to NIST SSDF, etc. that provide guidance on embedding security practices, for example throughout the software and/or hardware development lifecycle.
Security Forum Data—Information obtained from potentially public and/or semi-public sources, including but not limited to, online communities, discussion boards, and/or forums etc., for example in which cybersecurity issues, vulnerabilities, and/or product security practices may be discussed.
Security-Related Analyses—Evaluations, studies, analyses, computations, and/or automated assessments that may be conducted using commercial and/or open-source tools for example to identify, categorize, process, compute and/or measure cybersecurity risks and/or vulnerabilities.
Severity Sub-Rating—A sub-rating measuring, analyzing, processing, calculating, and/or scoring metrics pertaining to, but not limited to, a typical and/or average severity level of vulnerabilities for example historically associated with a vendor's product(s).
Supplemental Metrics—Additional contextual and/or supporting indicators used to refine and/or enhance cybersecurity rating calculations. For example, they may be used in conjunction with one or more raw product vulnerability field(s) to produce one or more baseline sub-rating(s).
Supply Chain Risk—The potential cybersecurity risk introduced through third-party components, dependencies, and/or vendors involved in the production and/or distribution of a given product(s).
Vendor Behavior—Observable actions, inactions, omissions, policies, and/or response patterns of a vendor relevant to cybersecurity practices/posture; including, but not limited to, incident transparency, communication quality, and/or remediation timeliness etc.
Vendor Blogs—Official and/or semi-official (e.g., online) publications released by vendors providing information including but not limited to updates, advisories, and/or discussions on product security and/or other organizational cybersecurity efforts.
Vendor(s), Manufacturer(s), and/or Supplier(s)—Entities engaged in activities such as, but not limited to, the design, development, production, and/or distribution of technology products, including, but not limited to, software, hardware, integrated systems, etc.
Vendor Metadata—Information related to a vendor, including, but not limited to, vendor size, organizational structure, industry sector, contextual data, and/or self-attestation data may be used for the normalization of vendor and/or product ratings.
Vendor Normalization and/or Product Normalization—The process(es) of adjusting vendor and/or product rating(s) to account for factors such as, but not limited to, contextual data, vendor size, market exposure, and/or typical thread surface with the aim of ensure equitable comparisons between vendors.
Vendor Release Notes—Documentation (for example including, but not limited to, blog posts, web pages, PDFs, etc.) published by a vendor describing information pertaining to a product(s) that may include, but is not limited to, changes, fixes, and/or updates in product versions, and may include details relevant to security patches, mitigations, and/or remediations.
Vendor Self-Attestation Data—Data that may include, but is not limited to, compliance documentation, vulnerability analysis results, etc. provided by one or more vendors such that one or more vendor(s) and/or product rating(s) may be adjusted for accuracy during vendor normalization.
Vendor Size Data—Data including, but not limited to, quantitative metrics of an organization's economic and/or operational scale, such as, but not limited to, revenue, employee count, market capitalization, and/or other relevant measurements, etc.
Vulnerability Disclosure Policy (VDP) Data—Data pertaining to a vendor's vulnerability disclosure policy, including, but not limited to, public availability, responsiveness, and/or clarity of procedures for external vulnerability reporting.

### 1) Use Case Diagram for a Vendor Cybersecurity Rating System

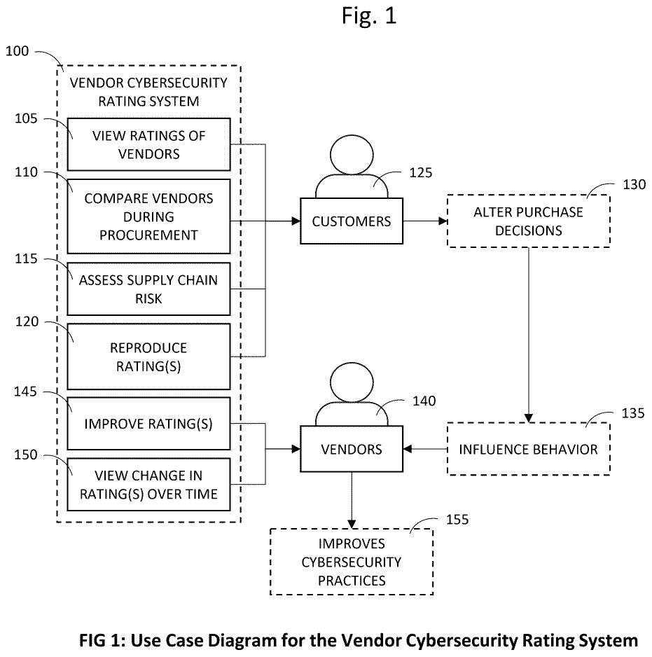

FIG. 1 depicts exemplary Use Cases (105-120, 145-150) for a Vendor Cybersecurity Rating System 100, illustrating how a system may interact with Customers 125, Vendors 140, and other entities. Customer-focused use cases may include, but are not limited to, Viewing Ratings of Vendors 105, Comparing Vendors During Procurement 110, Assessing Supply Chain Risk 115, and/or Reproducing Rating(s) 120. Vendor-focused use cases may include, but are not limited to, Improving Rating(s) 145 and/or Viewing Change in Rating(s) Over Time 150.

The number, type, arrangement, and order of components shown in FIG. 1 are merely illustrative. Components may be substituted, combined, omitted, rearranged, or supplemented in any manner without departing from the scope of the invention.

### 1.1) Vendor Cybersecurity Rating System

A Vendor Cybersecurity Rating System 100 may comprise, but is not limited to, a set of interconnected software and/or hardware components configured to collect, process, and/or analyze cybersecurity-related data from a wide range of data sources (e.g., public and/or private data sources, vendor-provided data sources, third-party data sources, etc.). Such a system may perform automated and/or semi-automated data ingestions, normalizations, and/or scoring operations to generate vendor and/or product cybersecurity ratings. Such ratings may be derived through analytical, mathematical, and/or statistical processes that may evaluate one or more factors, including but not limited to, known vulnerabilities, exploitability likelihood, remediation quality, security configurability, and/or communication transparency etc. A Vendor Cybersecurity Rating System 100 may further enable dissemination of rating-related information, including but not limited to, product and/or vendor ratings, underlying data sources, and/or calculation explanations etc., through mechanisms including, but not limited to, a web-based user interface (UI/UX), a Command Line Interface (CLI), application programming interface (API), rating visualizations, vendor and/or product ranking displays, etc. It may analyze, but is not limited to, products, vendors, sectors, and/or industries etc. It may determine industry-wide improvements, steps, and/or actions, etc., that may be taken to improve their cybersecurity posture.

### 1.2) Customer-Focused Use Cases

Viewing Ratings of Vendors 105 may involve, but is not limited to, customer access to vendor and/or product cybersecurity ratings via a UI/UX and/or application programming interface (API) etc. Customers may perform actions including, but not limited to, searching, filtering, merging, normalizing, aggregating, and/or sorting vendors across categories and/or product types to, for example, identify the most secure options. Vendor ratings may be provided and/or presented in any number of manners, including, but not limited to, numerically (e.g., as a percentage, and/or as a ratio, etc.), descriptively (e.g., “excellent”, “good”, “poor”, etc.), graphically (e.g., score bars, progress bars, charts, and/or graphs, etc.), leaderboards, and/or using color coordination (e.g., traffic-light style, etc.) etc.

Comparing Vendors During Procurement 110 may involve, but is not limited to, customers evaluating potential vendors and/or products in relation to one another during, for example, the procurement process, etc. This may, for example, enable customers to make informed purchasing decisions, understand vendor risks, and/or assess their supply chain(s), etc. Comparative visualizations may include, but are not limited to, side-by-side comparison of vendor and/or product ratings, leaderboards, ranking tables, pie charts, histograms, and/or rankings grids, etc.

Assessing Supply Chain Risk 115 may involve, but is not limited to, the analysis of upstream and/or downstream dependencies impacting the software and/or hardware owned by a customer or other entity for example, but not limited to, by integrating vendor and/or product ratings into existing supply chain management systems, compliance dashboards, DevSecOps and/or CI/CD pipelines, etc. Assessing Supply Chain Risk 115 may involve integration with documentation for supply chain transparency. For example, Assessing Supply Chain Risk 115 may integrate with a Software Bill of Materials (SBOM) and/or Artificial Intelligence Bill of Materials (AIBOM) to improve existing vulnerability documentation and/or reports, etc. Assessing Supply Chain Risk 115 may include scanning the products and/or vendors of an SBOM and/or AIBOM as input data for ratings and/or sub-ratings. Assessing Supply Chain Risk 115 may include scanning dependencies of vendors and/or products in a supply chain. Assessing Supply Chain Risk 115 may include creating a rating and/or sub-rating about the cybersecurity of a vendor's full and/or partial supply chain.

Reproduce Rating(s) 120 may involve, but is not limited to, providing transparency and/or auditability through a reproducibility engine. A reproducibility engine may comprise one or more software and/or hardware components configured to expose, document, and/or visualize process that may be end-to-end by which vendor and/or product cybersecurity ratings and/or sub-ratings may be derived. In certain implementations, a reproducibility engine may disclose for example, but not limited to, the data sources utilized in at least one calculation process, the applied data normalization and/or transformation techniques, artificial intelligence models used, mathematical and/or statistical models employed (e.g., weighting functions, aggregation formulas, regression or machine learning models, etc.), and/or the computational steps leading to a complete primary rating and/or sub-rating(s).

### 1.3) Customer Impact

A vendor cybersecurity rating system may impact Customers 125 or other entities. It may be analyzed through Altering Purchase Decisions 130. This impact may encompass, but is not limited to, influencing the vendor(s) and/or product(s) a customer may choose to procure (e.g., in favor of more secure vendor(s) and/or product(s)), modifying customer procurement preferences over time, and/or shaping long-term perceptions of vendor trustworthiness and/or product security quality, etc.

A vendor cybersecurity rating system may provide alerts that a vendor (for example, that is of interest and/or is suggested) has had a rating, sub-rating, and/or leaderboard change. Alerts may include, but are not limited to, sending an email, sending a text, playing audio over a speaker, and/or displaying information on a tablet, etc.

A vendor cybersecurity rating system may provide risk scores based on the supply chains of any number of vendors. It may provide remediation guidance related to how to upgrade and/or patch a vendor's products. It may provide an interface where a customer can weigh their vendor and/or product preferences, for example with a comparative table, sliders and/or scores for features like security, vendor size, product popularity, fit to use case, etc. It may return any number of best fit vendors and/or products.

### 1.4) Vendor-Focused Use Cases

Improve Ratings 145 may involve, but is not limited to, features and/or functionalities of a vendor cybersecurity system designed to, but not limited to, inform and/or guide vendors on improving their cybersecurity practices and/or overall rating performance over time, etc. Such features and/or functionalities may include, but are not limited to:
automated diagnostic analysis which may, upon generation and/or update of a vendor's rating, automatically analyze sub-rating performance to, for example, detect statistically significant deficiencies and/or patterns of underperformance. This analysis may identify, for example, but not limited to, recurring vulnerability classes, delayed patch timelines, missing documentation, and/or low explainability/readability in vendor communications, etc. This analysis may automatically make changes to a system, such as, but not limited to, patching a software vulnerability, modifying configuration files, and/or modifying source code, etc.;
context-aware remediation recommendations which may (e.g., using rule-based logic and/or machine learning models, etc.) for example generate recommendations suggesting corrective actions, including but not limited to, suggesting secure product development techniques to reduce recurring classes of vulnerabilities, suggesting more efficient product management strategies to improve patch timelines, suggesting how to write missing documentation for specific product categories, and/or suggesting re-phrasing of difficult to understand syntax and/or semantics in vendor communications, etc.;
interactive and/or intelligent advisory interfaces for example including, but not limited to, an LLM-based chatbot capable of providing query-driven guidance which vendors may interact with to for example ask questions, obtain explanations of rating and/or sub-ratings, and/or receive step-by-step remediation advice aligned with recognized cybersecurity frameworks (e.g., NIST SSDF, CISA Secure-by-Design, etc.), etc. Such an LLM-based chatbot may utilize techniques including, but not limited to, retrieval augmented generation (RAG) (e.g., to incorporate vendor and/or product ratings, to incorporate cybersecurity compliance documents, etc.), vector databases, agentic tools, etc.;
remediation tracking and/or verifications wherein vendors may perform actions including, but not limited to, submitting evidence of completed remediation activities (e.g., updated documentation, vulnerability patch data, compliance certifications, etc.) and/or viewing the improvement due to such activities in their rating(s) and/or sub-rating(s), etc.;
a badge, trust mark, and/or certificate that a vendor may for example display digitally and/or physically showing their rating(s) and/or ranking(s), etc.
and/or graphical user interface (GUI) components that may visualize a vendor's historical Change in Rating(s) Over Time 150 (for example, line charts illustrating annual and/or periodic changes in a vendor's cybersecurity rating and/or sub-rating(s), etc.).

### 1.5) Vendor Impact

A vendor cybersecurity rating system may Influence Behavior 135 of Vendors 140, for example, but not limited to, through the Altered Purchase Decisions 130 of Customers 125. By making cybersecurity performance visible and/or comparable across vendors, a system may, among other things, fosters healthy competition between vendors of the same category and/or with similar products, creates financial and/or reputational incentives for changes in behavior, etc.

An objective of a vendor cybersecurity rating system may be to Improve the Cybersecurity Practices 155 of vendors or other entities. This may include, but is not limited to, increasing vendor alignment with standards, guidelines, and/or best practices, for example federal directives and/or initiatives such as CISA's Secure-by-Design principles; enhancing secure product development processes; and/or encouraging greater vendor willingness to explain, disclose, and/or remediate vulnerabilities in their products in a timely and/or transparent manner, etc. It may include a feedback loop that continually improves feedback over time based on feedback that worked better for other vendors and/or products. It may analyze historical correlations between prior feedback actions and subsequent rating improvements. It may analyze where similar vendors, such as in product category, and/or vendor size, etc., have higher sub-ratings and provide tailored feedback to improve. It may include steps that were taken by other vendors that a vendor may take to optimize the speed in which they improve their score and/or the amount they increase it, etc. It may include cybersecurity tools to scan updated inputs, such as new code commits and/or binary files, to project how their score would be impacted if applied. In an example, a vendor cybersecurity rating system may be integrated directly into an IDE and/or other coding environment to get real-time scoring updates.

In an example, a vendor cybersecurity rating system may include a cybersecurity maturity rating that may aim to Improve the Cybersecurity Practices 155 of vendors by measuring a vendor's progression towards industry best practices.

In an example, a vendor cybersecurity rating system analyzes steps that previously were effective and/or sustainable and provides a customizable plan and/or timeline for how to improve a vendor's cybersecurity posture. It may include information tailored to their specific issues and/or prior successes and/or failures in improving their score, etc.

### 2) Component(s) of Vendor Cybersecurity Rating System Architecture

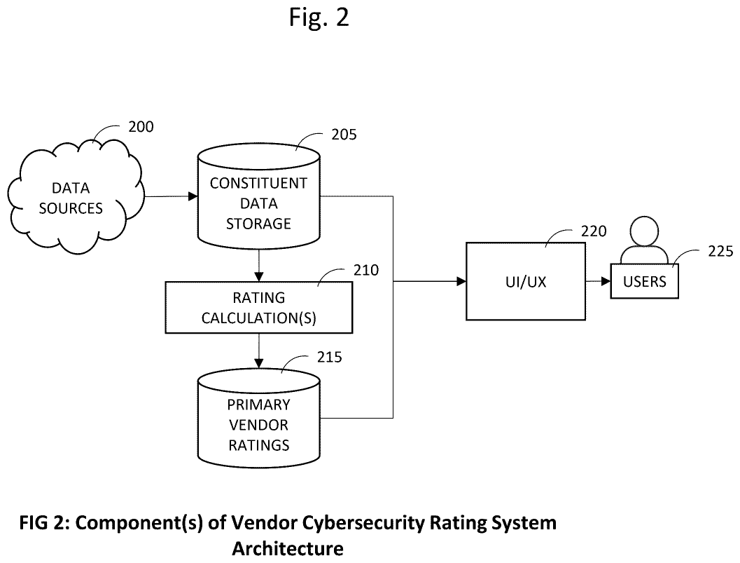

FIG. 2 depicts an exemplary system architecture of the vendor cybersecurity rating system. The system may begin with the ingestion of data from at least one Data Source 200. The collected data may be processed through one or more Rating Calculation(s) 210 to generate one or more Primary Vendor Ratings 215. Resulting ratings may be disseminated through a User Interface/User Experience (UI/UX) 220, which may make the information accessible to Users 225, including customers, vendors, and/or other entities.

The number, type, arrangement, and order of components shown in FIG. 2 are merely illustrative. Components may be substituted, combined, omitted, rearranged, or supplemented in any manner without departing from the scope of the invention.

### 2.1) Data Ingestion

Data may be ingested from one or more Data Sources 200. Data Sources 200 may include, but are not limited to, publicly available vulnerability databases, security advisories, Common Vulnerabilities and Exposures (CVEs), Known Exploited Vulnerabilities (KEVs), product manuals, security forum data, vendor self-attestation data, and other relevant repositories, etc. The collected data, metadata, and/or additional supporting information, may comprise the Constituent Data Storage 205.

The Constituent Data Storage 205 may be implemented using one or more data storage mechanisms, including, but not limited to, database tables, distributed databases, file systems, relational databases, vector databases, document-oriented databases, and/or other forms of persistent storage, etc. Collecting vendor self-attestation data may include, but is not limited to, providing a survey and/or framework, fillable form, and/or automated assessment, etc. It may include data from a third-party assessment. It may provide information for (for example newer) vendors and/or products to be onboarded and/or to improve their score.

Automated web-scraping of the Data Sources 200 may be performed on a frequent, scheduled, periodic, continuous, and/or recurring basis, such that the Constituent Data Storage 205 may contain the most recent iteration of all or most relevant data sources. In an example, Data Sources 200 may be retrieved when an action is performed, such as, but not limited to, a commit in a code repository, an issue created and/or resolved in a code repository, a new software build, release notes released, and/or a merge request created and/or completed, etc. Data ingestion may include processes for, but is not limited to, pre-processing, normalizing, and/or validating.

### 2.2) Rating Generation

Data retrieved from Constituent Data Storage 205 may be processed by one or more Rating Calculation(s) 210, which may perform analytical and/or mathematical operations to generate cybersecurity sub-ratings and/or aggregate vendor-level scores. Such operations may include, but are not limited to, calculating sub-ratings corresponding to specific cybersecurity dimensions (e.g., exploitability, remediability, configurability, and/or generic sub-ratings, etc.) and/or aggregating these sub-ratings using methodologies such as weighted and/or unweighted averages, statistical modeling, and/or artificial intelligence (AI) and/or machine learning (ML) techniques, etc.

Data and/or scores produced by the Rating Calculation(s) 210 may comprise the Primary Vendor Ratings 215, which may represent the aggregate and/or overall measure of a vendor's and/or product's cybersecurity posture and/or performance, etc. A rating calculation may include a risk score for how likely a vendor and/or product will be impacted by an emerging, previously unseen threat. It may include predictive modeling for evaluating how likely a product and/or vendor will be impacted and/or respond to a new vulnerability and/or risk, etc.

In an example, if data is not provided by a vendor and/or cannot be found, a vendor may receive, for example (but not limited to), a warning, a lower Primary Vendor Ratings 215, and/or a vendor's ratings may be approximated despite the missing data, etc. In an example, Rating Calculation(s) 210 may retrieve alternative data sources to fill in gaps in data collection.

Primary Vendor Ratings 215 may be stored using at least one persistent data storage mechanism. Persistent data storage mechanisms may include, but are not limited to, database tables, distributed databases, file systems, relational databases, vector databases, document-oriented databases, and/or other persistent data storage systems, to enable features such as, but not limited to efficient retrieval, updating, and/or publication of rating results, etc. Primary Vendor Ratings 215 and/or Rating Calculation(s) 210 may be used to identify and/or prioritize potential security risks for each vendor or other entity.

### 2.3) Rating Publication

Primary Vendor Ratings 215 may be disseminated through a User Interface/User Experience (UI/UX) 220. For example, a UI/UX 220 may include, but is not limited to, a web-based portal, public-facing website, and/or network-accessible application programming interface (API) (e.g., HTTP, RESTful, JSON, etc.). A UI/UX 220 may support any number of features and/or functionalities, including, but not limited to, viewing, querying, searching, comparing, and/or ranking vendors and/or products, as well as other forms of interactive engagement with cybersecurity rating data, etc.

As an example, a UI/UX 220 may enable users to view a knowledge base. A knowledge base may include function modules including, but not limited to, vendor profiles (e.g., organization overview, products, past security incidents, security certifications, and/or compliance, etc.), security incident data (e.g., causes of breach, number and severity of affected systems or data, corrective actions taken, etc.), primary ratings and/or sub-ratings, etc.

Users 225 includes for example vendors, customers, and/or other entities, whom may derive distinct and/or shared benefits from the vendor cybersecurity rating system. Benefits may for example be in alignment with those described as illustrated in FIG. 1.

### 2.4) Multi-Agent Example

An example of a vendor cybersecurity rating system may be designed as a multi-agent system. It may include, but is not limited to, a vendor agent that can extract and/or reason about data about a vendor, product agent that can extract and/or reason about data about a product, industry agent that can extract and/or reason about data about an industry, security expert agent that can extract and/or reason about security risks, etc. It may include an orchestrator agent that communicates with other AI agents. Agents may be specialized in areas including, but not limited to, application security, cloud security, and/or IoT security, etc. Agents may contribute and/or calculate sub-ratings and/or calculate primary ratings.

### 3) Functional Diagram for Primary Vendor Rating Calculation

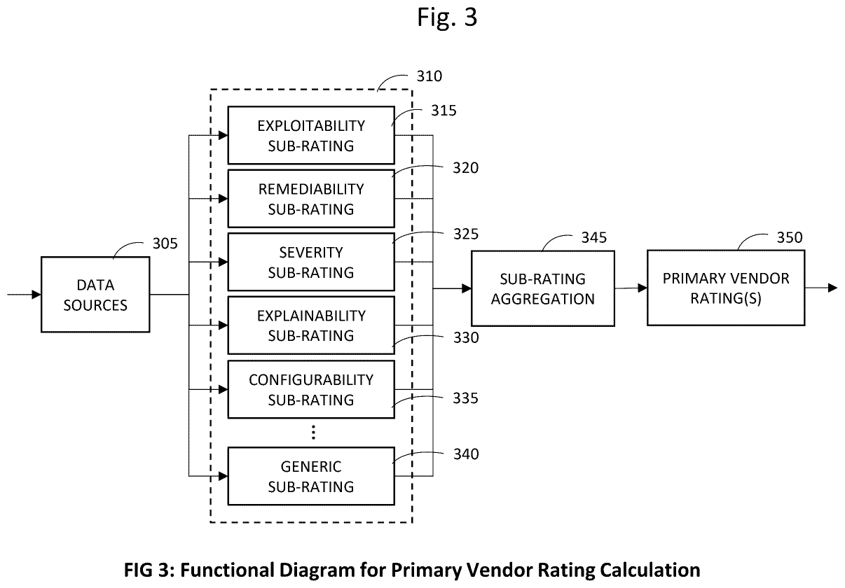

FIG. 3 illustrates an exemplary functional diagram outlining example principal steps which may be involved in generating primary vendor rating(s) in an example of the vendor cybersecurity rating system. The process may include data flow from at least one Data Source 305, followed by the Calculation of Sub-Rating(s) 310, subsequent Sub-Rating Aggregation 345, and a production of the resulting Primary Vendor Rating(s) 350. FIG. 3 may be thought of as a higher-fidelity depiction of FIG. 2's Rating Calculation(s) 210 and/or Primary Vendor Ratings 215.

The number, type, arrangement, and order of components shown in FIG. 3 are merely illustrative. Components may be substituted, combined, omitted, rearranged, or supplemented in any manner without departing from the scope of the invention.

### 3.1) Sub-Rating Calculation(s)

Data Sources 305, may include, but are not limited to, publicly available vulnerability databases, private databases, security advisories, Common Vulnerabilities and Exposures (CVEs), Known Exploited Vulnerabilities (KEVs), product manuals, security forum data, vendor self-attestation data, and other relevant repositories. Data Sources 305 may be used in the Calculation of Sub-Rating(s) 310.

Calculation of Sub-Rating(s) 310 may comprise the analytical and/or mathematical operations required to generate one or more distinct sub-ratings. Such calculations may be executed sequentially or in parallel across any number of sub-rating categories. Although FIG. 3 illustrates exemplary sub-ratings, Calculation of Sub-Rating(s) 310 is not limited to these specific examples. An Exploitability Sub-Rating 315 may measure how easily a vulnerability can be exploited by an attacker. A Remediability Sub-Rating 320 may assess the ease and feasibility of remediating a vulnerability and/or addressing other security concerns. A Severity Sub-Rating 325 may evaluate the impact of a vulnerability being exploited on a customer's assets, data and/or operations, etc. An Explainability Sub-Rating 330 may assess a vendor's ability to communicate security incidents, vulnerabilities, and/or mitigations clearly and/or accurately to customers and/or the public. A Configurability Sub-Rating 335 may evaluate the ease with which a customer can configure security settings for a product and/or may include the availability of advanced features and compliance, for example with standards, guidelines and/or best practices.

This process may operate independently of any particular sub-rating and may incorporate additional and/or alternative sub-ratings not explicitly described herein. This conceptual flexibility may be represented by a Generic Sub-Rating 340 depicted in FIG. 3, which may represent other potential sub-rating models that may share certain attributes with the described examples, such as the use of comparable data sources, data flow methodologies, supplemental metrics, and/or vendor normalization techniques.

A set of sub-ratings selected for inclusion in the Calculation of Sub-Rating(s) 310 may be determined automatically (e.g., selecting all defined sub-ratings, selecting based on vendor and/or product category, selecting based on search, sort, and/or filter criteria, etc.) and/or may be manually specified through user input. A selected set of sub-ratings may or may not reflect the exact set of sub-ratings illustrated in FIG. 3.

### 3.2) Sub-Rating Aggregation

A Sub-Rating Aggregation 345 process may involve, but is not limited to, combining one or more sub-ratings into a composite score using one or more aggregation methodologies. These methodologies may include, but are not limited to, weighted and/or unweighted averaging, statistical modeling, and/or artificial intelligence (AI) or machine learning (ML) techniques. The aggregation process may produce at least one Primary Vendor Rating(s) 350, which may represent combined (e.g., overall, holistic) measure of a vendor's and/or a product's cybersecurity posture.

A Sub-Rating Aggregation 345 process may dynamically include, exclude, and/or reweigh certain sub-ratings based on vendor-specific characteristics such as vendor size, availability of data, market exposure, and/or other contextual factors.

### 4) Functional Diagram for Exploitability Sub-Rating Calculation

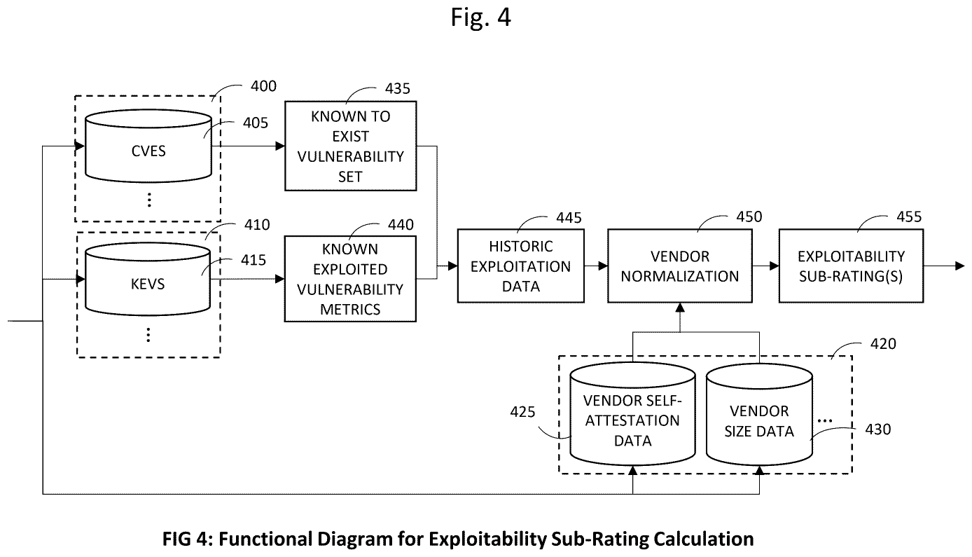

FIG. 4 illustrates an exemplary process for calculating at least one Exploitability Sub-Rating(s) 455 in an example of the vendor cybersecurity rating system. For example, a sub-rating may characterize and/or assess the likelihood that vulnerabilities associated with a vendor and/or product could be successfully exploited by malicious actors. The calculation may incorporate, combine, and/or derive data from at least one source, including, but not limited to, Common Vulnerabilities and Exposures (CVEs) 405, Known Exploited Vulnerabilities (KEVs) 415, Vendor Self-Attestation Data 425, and/or Vendor Size Data 430.

The number, type, arrangement, and order of components shown in FIG. 4 are merely illustrative. Components may be substituted, combined, omitted, rearranged, or supplemented in any manner without departing from the scope of the invention.

### 4.1) Historic Exploitation Data

Historic Exploitation Data 455 may represent information describing, among other factors, the frequency and/or nature of past security exploitations affecting a vendor and/or product. In this context, “exploitation” may refer to the successful and/or attempted use of known vulnerabilities by malicious actors to compromise, disrupt, and/or gain unauthorized access to systems and/or data etc. Historic Exploitation Data 445 may be synthesized from at least one data source, including but not limited to a Known-to-Exist Vulnerability Set 435 and/or Known Exploited Vulnerability Metrics 440.

As an example, a vendor cybersecurity rating system may analyze Historic Exploitation Data 455 for patterns, anomalies and/or trends, etc. A vendor cybersecurity rating system may determine insights including, but not limited to, which vendors and/or products, etc., get targeted by attackers most frequently. As an example, to identify patterns, a vendor cybersecurity rating system may group similar attack patterns, assess temporal trends and/or correlations between events, and/or perform anomaly detection to pinpoint deviations from normal attack patterns, etc.

As an example, Historic Exploitation Data 445 may be displayed as a visual timeline including, but not limited to, security risks, vulnerabilities, technical actions taken to resolve vulnerabilities, and/or actions taken to improve a vendor's cybersecurity posture, etc.

A Known-to-Exist Vulnerability Set 435 may encompass data describing security vulnerabilities that are known to currently exist and/or have previously existed within a vendor's product(s). This dataset may include, but is not limited to, information pertaining to vulnerability classifications, quantities, descriptions, and/or discovery timestamps. A Known-to-Exist Vulnerability Set 435 may be generated from Product Vulnerability Data 400, which may comprise at least one data source that may catalog vulnerability details, for example including, but not limited to, Common Vulnerabilities and Exposures (CVEs) 405.

A Known Exploited Vulnerability Metrics 440 may capture information relating to vulnerabilities that have been actively exploited by malicious actors. These metrics may include, but are not limited to, data regarding the severity, frequency, and/or impact of such exploitation events etc. Known Exploited Vulnerability Metrics 440 may be derived from Additional Data 410, which comprises at least one data source describing historical exploitation activity associated with specific vendors and/or products, including, but not limited to, Known Exploited Vulnerabilities (KEVs) 415 and/or related datasets, etc.

### 4.2) Vendor Normalization

Vendor Normalization 450 may involve any number of adjustments and/or calibrations of the Historic Exploitation Data 445. The process may account for contextual differences among vendors. This may encompass a wide range of factors, including but not limited to organizational size, market presence, product portfolio breadth, and/or overall exposure surface etc. In an example, Vendor Normalization 450, when used in connection with an exploitability sub-rating calculation, may ensure equitable evaluation of vendors may be targeted by malicious actors either more or less frequently than the industry average.

Vendor Normalization 450 may use Vendor Metadata 420. This metadata may comprise at least one data source including, but not limited to, Vendor Self-Attestation Data 425 and/or Vendor Size Data 430 to perform any number of adjustments and/or calibrations of Historic Exploitation Data 445 including, but not limited to, correcting any falsely-recorded exploits using data supplied by a vendor, accounting for larger-sized vendors who may be more likely to be targeted for exploitation, etc.

Vendor Normalization 450 of Historic Exploitation Data 445 may result in a complete Exploitability Sub-Rating(s) 455.

### 5) Functional Diagram for Remediability Sub-Rating Calculation

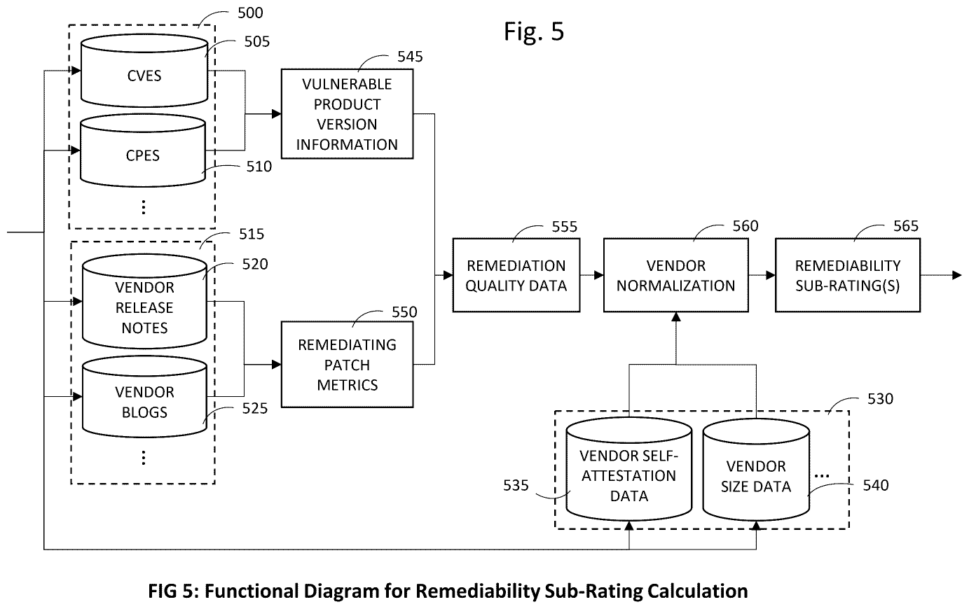

FIG. 5 illustrates an exemplary process for calculating at least one Remediability Sub-Rating(s) 565 in an example of the vendor cybersecurity rating system. For example, a sub-rating may characterize and/or assess a vendor or other entity's responsiveness and/or effectiveness in addressing and/or resolving identified vulnerabilities through timely patches and/or updates. The calculation may incorporate, combine, and/or derive data from at least one source. Sources may include, but not limited to, Common Vulnerabilities and Exposures (CVEs) 505, Common Platform Enumerations (CPEs) 510, Vendor Release Notes 520, Vendor Blogs 525, Vendor Self-Attestation 535, and/or Vendor Size Data 540 etc.

The number, type, arrangement, and order of components shown in FIG. 5 are merely illustrative. Components may be substituted, combined, omitted, rearranged, or supplemented in any manner without departing from the scope of the invention.

### 5.1) Remediation Quality Data

Remediation Quality Data 555 may represent information describing for example the quality and/or extent of past remediation actions undertaken by a vendor. Such actions may include, but are not limited to, the release of product version updates, software patches, and/or vulnerability mitigation advisories etc. The Remediation Quality Data 555 may be synthesized from at least one data source, including, but not limited to, Vulnerable Product Version Information 545 and/or Remediating Patch Metrics 550 etc.

The Vulnerable Product Version Information 545 may encompass data describing the version history of a vendor's product(s) and/or the existence of any number of vulnerable product versions, etc. This may include, but is not limited to, information related to unique product and/or version identifiers, identifiers associated with known vulnerabilities and/or exploits, and/or identifiers associated with security-related patches and/or updates etc. The Vulnerable Product Version Information 545 may be derived from Product Vulnerability Data 500, which comprises at least one data source cataloging product version details, including, but not limited to, Common Vulnerabilities and Exposures (CVEs) 505 and/or Common Platform Enumerations (CPEs) 510 etc.

Remediating Patch Metrics 550 may capture information related to, but not limited to, the impact, timeliness, visibility, and/or overall quality of vendor-issued updates, patches, mitigations, and/or advisories etc. These metrics may be derived from Additional Data 515, which may comprise at least one data source describing historical remediation activity associated with specific vendors and/or products, including, but not limited to, Vendor Release Notes 520, Vendor Blogs 525, and/or other related datasets etc.

### 5.2) Vendor Normalization

Vendor Normalization 560 may involve any number of adjustments and/or calibrations of the Remediation Quality Data 555. Vendor normalization may account for contextual differences among vendors. Vendor normalization may encompass a wide range of factors, including but not limited to organizational size, market presence, product portfolio breadth, and/or overall exposure surface etc. In an example, Vendor Normalization 560, when used in connection with a remediability sub-rating calculation, may ensure equitable evaluation of vendors that have more or less products and/or more or less product versions than the industry average.

Vendor Normalization 560 may use Vendor Metadata 530. This metadata may comprise any number of data sources including, but not limited to, Vendor Self-Attestation Data 535 and/or Vendor Size Data 540 to perform any number of adjustments and/or calibrations of the Remediation Quality Data 555 including, but not limited to, incorporating data supplied by a vendor pertaining to any missing and/or unrecorded patches, accounting for larger-sized vendors who may have more products, etc.

Vendor Normalization 560 of Remediation Quality Data 555 may result in a complete Remediability Sub-Rating(s) 565.

### 6) Functional Diagram for Severity Sub-Rating Calculation

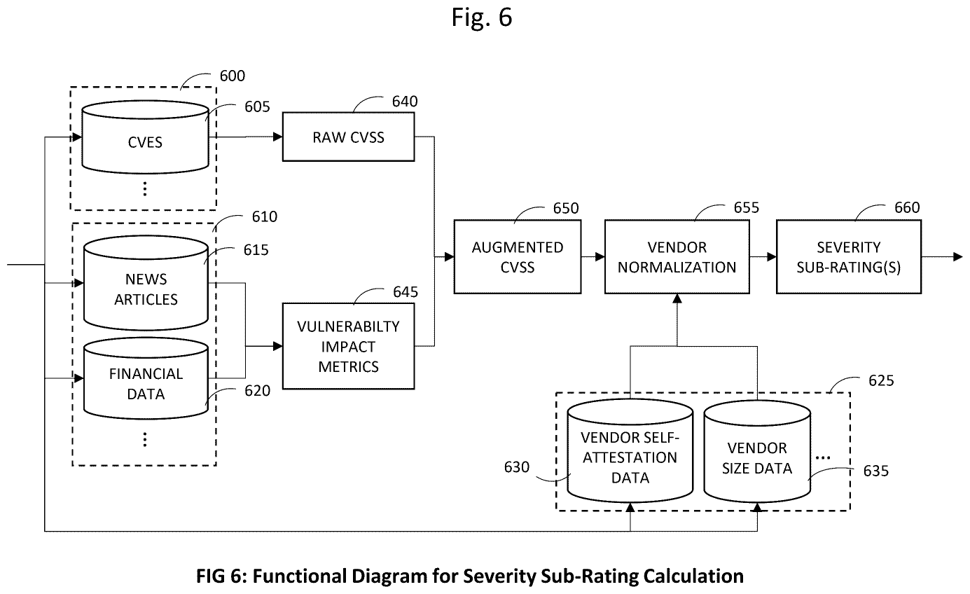

FIG. 6 illustrates an exemplary process for calculating at least one Severity Sub-Rating(s) 660 in an example of the vendor cybersecurity rating system. For example, a sub-rating may characterize and/or assess the severity level of vulnerabilities associated with a vendor or other entity's product(s). A calculation may incorporate, combine, and/or derive data from at least one source. Sources may include, but are not limited to, Common Vulnerabilities and Exposures (CVEs) 605, News Articles 615, Financial Data 620, Vendor Self-Attestation Data 630, and/or Vendor Size Data 635 etc.

The number, type, arrangement, and order of components shown in FIG. 6 are merely illustrative. Components may be substituted, combined, omitted, rearranged, or supplemented in any manner without departing from the scope of the invention.

### 6.1) Augmented CVSS

Augmented CVSS 650 may represent information describing statistical characteristics of vulnerabilities affecting a vendor's products. Calculating augmented CVSS may include, among other factors, the average, maximum, median, and/or other relevant measures, of the Common Vulnerability Scoring System (CVSS) scores associated with vulnerabilities present in a vendor's product(s). Augmented CVSS may be refined through one or more adjustments based on additional vulnerability impact information, including, but not limited to, publicly reported incidents, news coverage, and/or financial and/or operational impact data etc. Augmented CVSS 650 may be synthesized from at least one data source, including, but not limited to, Raw CVSS 640 and/or Vulnerability Impact Metrics 645 etc.

Raw CVSS 640 may capture information pertaining to, but not limited to, the Common Vulnerability Scoring System (CVSS) scores associated with vulnerabilities identified within a vendor's product(s). Each CVSS and/or similar score may incorporate one or more components, including, but not limited to, attack vector, attack complexity, privileges required, user interaction, and/or impacts on confidentiality, integrity, and/or availability, as well as temporal and/or environmental metrics etc. Raw CVSS 640 may encompass one or more CVSS versions (e.g., CVSS v2.0, v3.0, v3.1, v4.0, etc.). Raw CVSS 640 may be derived from Product Vulnerability Data 600, which comprises at least one data source cataloging historical vulnerability severity levels related to specific vendors and/or products, including, but not limited to, Common Vulnerabilities and Exposures (CVEs) 605 and/or other relevant datasets etc.

Vulnerability Impact Metrics 645 may represent information describing the real-world impact of vulnerabilities in a vendor's product(s) on affected individuals, organizations, and/or other end-user entities. Impacts may include, but are not limited to, financial loss, reputational damage, operational disruption, and/or data exposure etc. Metrics may be generated from Additional Data 610, which comprises at least one data source documenting historical vulnerability consequences and/or their severity, including, but not limited to, News Articles 615 and/or Financial Data 620, and/or other related datasets etc.

### 6.2) Vendor Normalization

Vendor Normalization 655 may involve any number of adjustments and/or calibrations of the Augmented CVSS 650. Vendor normalization may account for contextual differences among vendors. Vendor normalization may encompass a wide range of factors, including but not limited to organizational size, market presence, product portfolio breadth, and/or overall exposure surface etc. In an example, Vendor Normalization 655, when used in connection with a severity sub-rating calculation, may ensure equitable evaluation of vendors operating within domains of varying sensitivity, for example, vendors of products in medical and/or financial sectors versus those in less critical industries, where the natural distribution of vulnerability severity may differ due to environmental and/or regulatory factors.

Vendor Normalization 655 may use Vendor Metadata 625. Vendor metadata may comprise at least one data source including, but not limited to, Vendor Self-Attestation Data 630 and/or Vendor Size Data 635 to perform any number of adjustments and/or calibrations of the Augmented CVSS 650 including, but not limited to, incorporating data supplied by a vendor related to for example biased and/or unbiased news articles, accounting for smaller-sized vendors who may be in niche, but highly-critical industries, etc.

Vendor Normalization 655 of Augmented CVSS 650 may result in a complete Severity Sub-Rating(s) 660.

### 7) Functional Diagram for Explainability Sub-Rating Calculation

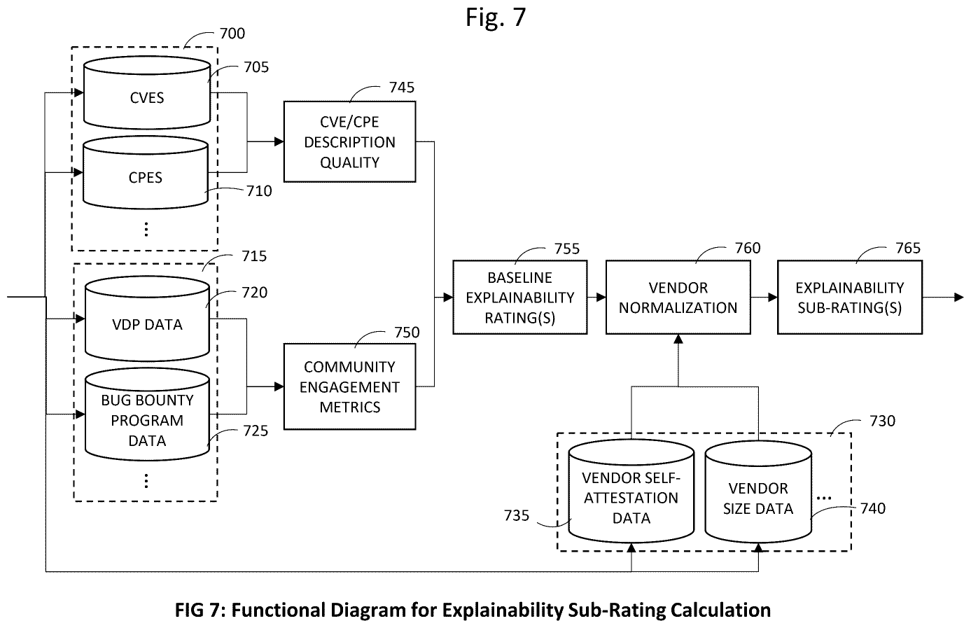

FIG. 7 illustrates an exemplary process for calculating at least one Explainability Sub-Rating 765 in an example of the vendor cybersecurity rating system. For example, a sub-rating may characterize and/or assess a vendor or other entity's communication. Characterizations may include, but is not limited to, their communication quality, such as their ability to communicate information relating to security incidents, vulnerabilities, and/or mitigations clearly, their communication granularity, such as how detailed their communication is, and/or communication accuracy, such as how complete they describe the steps to reproduce and/or validate the security incident, vulnerability and/or mitigation, etc. The calculation may incorporate, combine, and/or derive data obtained from at least one source. Sources may include, but are not limited to, Common Vulnerabilities and Exposures (CVEs) 705, Common Platform Enumerations (CPEs) 710, Vulnerability Disclosure Policy (VDP) Data 720, Bug Bounty Program Data 725, Vendor Self-Attestation Data 735, and/or Vendor Size Data 740 etc. In an example, this score may include details regarding an entity other than a vendor, such as a third-party clearinghouse, and/or product user, etc.

The number, type, arrangement, and order of components shown in FIG. 7 are merely illustrative. Components may be substituted, combined, omitted, rearranged, or supplemented in any manner without departing from the scope of the invention.

### 7.1) Baseline Explainability Rating(s)

Baseline Explainability Rating(s) 755 may represent information pertaining to a vendor's past and/or ongoing communications. Explainability related information may include, among other factors, the quality, quantity, clarity, readability, and/or comprehensiveness etc. Explainability related information may relate to the communications regarding product vulnerabilities and/or related security matters. Explainability related communications may occur through any suitable medium, for example including but not limited to, vulnerability disclosures, product advisories, and/or interactions with relevant communities such as customer, security research, and/or governmental and/or regulatory bodies etc. The Baseline Explainability Rating(s) 755 may be synthesized from at least one data source, including, but not limited to, CVE/CPE Description Quality 745, and/or Community Engagement Metrics 750.

CVE/CPE Description Quality 745 may capture information pertaining to, but not limited to, the quality, quantity, clarity, readability, and/or overall comprehensiveness of the textual descriptions associated with Common Vulnerabilities and Exposures (CVEs) and/or Common Platform Enumerations (CPEs) relevant to a vendor's product(s) and/or their known vulnerabilities, etc. Description quality metrics may be derived using linguistic and/or readability assessment methodologies, including, but not limited to, readability tests, such as Flesch-Kincaid scoring, Gunning Fog Index, SMOG Index, and/or Automated Readability Index (ARI), LLM-as-a-Judge, such as LLM-based (or other AI based) language quality scoring, and/or other statistical and/or artificial intelligence (AI)/machine learning (ML)-based techniques designed to estimate reading comprehension and/or textual understandability etc.

For example, an LLM used for explainability quality assessment may be provided any number of evaluation prompts, input data to score, and/or gold standards (such as, but not limited to, represent a very detailed and/or accurate vulnerability disclosure) etc. In an example, LLM-based explainability quality assessment may include one or more LLMs that judge different information pertaining to the at least one textual description. LLM-based explainability quality assessment may for example include at least one model fine-tuned specifically for judging. LLM-based explainability quality assessment may for example include at least one AI agent for scoring the at least one textual description. In an example, LLM-based explainability quality assessment may use at least one classifier model and/or a combination of approaches. In an example, LLM-based explainability quality assessment may produce at least one type of evaluation, including but not limited to, assigning at least one numerical score, comparing outputs and selecting the better one based on any number of criteria, providing a Boolean output, a description of whether it meets criteria, and/or comparing against a reference, etc. In an example, LLM-based explainability quality assessment may provide at least one rationale, explainability metric, and/or transparency metric, etc. Metrics may for example provide reasoning behind its decision-making. Metrics may for example include natural language descriptions of data sources and methodologies used in calculations. For example, explanations may be for how each vendor's input data contributed to their overall score, visualization tools that display the contribution of each factor to the overall score, confidence intervals or uncertainty estimates for sub-ratings, audit trails or logs of all inputs, outputs, and decision-making processes, explanations of why and how the score changed over time, and/or or interactive dashboards that allow users to explore and drill down into specific scores. LLM-based explainability quality assessment may pre-process data prior to it being provided to the AI model, such as but not limited to, removing stop words, translating formats such as HTML, PDF, and/or DOCX to text, and/or formatting code, etc. LLM-based explainability quality assessment may post-process results, such as, but not limited to, extracting numerical values, removing redundant information, etc. LLM-based explainability quality assessment may provide the output, for example, to another model to explain its rationale.

CVE/CPE Description Quality 745 data may be obtained from Product Vulnerability Data 700, which comprises one or more data sources that capture written explanations and/or documentation of vulnerabilities and/or products. This may include, but are not limited to, those originating from federal, regulatory, and/or governmental contexts—including, but not limited to, CVEs 705 and/or CPEs 710 and/or other related datasets.

In an example, Community Engagement Metrics 750 may represent information describing for example the quality, quantity, clarity, readability, and/or overall comprehensiveness of a vendor and/or other entity's historical and/or ongoing communications relating to product vulnerabilities, security readiness, and/or related security matters etc. This information may be derived from, but is not limited to, non-federal, non-regulatory, and/or non-governmental contexts, including, but not limited to, interactions with customers, independent security researchers, and/or the broader cybersecurity community etc. Community Engagement Metrics 750 may be generated from Additional Data 715, which may comprise one or more data sources, including, but not limited to, Vulnerability Disclosure Policy (VDP) Data 720, Bug Bounty Program Data 725, and/or as other vulnerability datasets.

### 7.2) Vendor Normalization

Vendor Normalization 760 may involve any number of adjustments and/or calibrations of Baseline Explainability Rating(s) 755. Vendor normalization may account for contextual differences among vendors. Vendor normalization may encompass a wide range of factors, including but not limited to organizational size, market presence, product portfolio breadth, financial resources, labor resources, audience size, customer base, and/or overall exposure surface etc. In an example, Vendor Normalization 760, when used in connection with an explainability sub-rating calculation, may support and/or facilitate equitable evaluation of vendors and/or other entities operating, regardless of differences in for example audience size, customer base, publicity capability, or other contextual factors that may influence the dissemination and/or accessibility of security-related information. Vendor normalization may adjust for disparities in financial and/or labor resources that may influence a vendor's ability to produce, disseminate, and/or maintain clear and/or transparent security communications.

Vendor Normalization 760 may use Vendor Metadata 730. Vendor normalization metadata may comprise at least one data source about a vendor including, but not limited to, Vendor Self-Attestation Data 735 and/or Vendor Size Data 740 to perform any number of adjustments and/or calibrations of the Baseline Explainability Rating(s) 755 including, but not limited to, incorporating data supplied by a vendor related to any bug-bounty programs and/or vulnerability disclosure policies they may have that the initial data sources did not account for, accounting for smaller-sized vendors who may not have the financial resources to support a bug-bounty program and/or vulnerability disclosure policy, etc.

Vendor Normalization 760 of Baseline Explainability Rating(s) 755 may result in a complete Explainability Sub-Rating(s) 765.

### 8) Functional Diagram for Configurability Sub-Rating Calculation

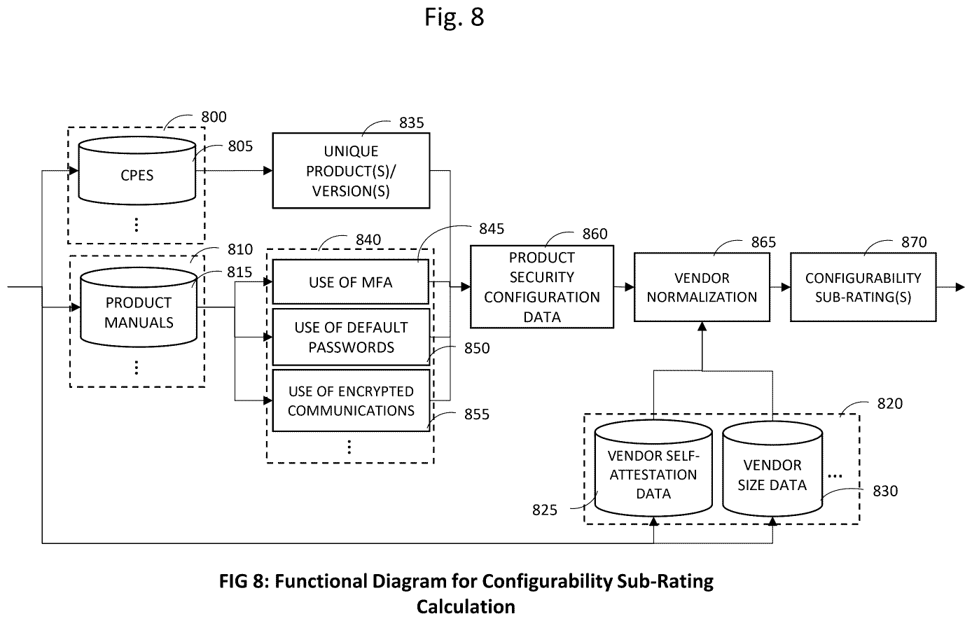

FIG. 8 illustrates an exemplary process for calculating a Configurability Sub-Rating(s) 870 in an example of the vendor cybersecurity rating system, which may assess for example the degree to which a product and/or vendor allows secure configuration by end-users, including for example the presence of security options and/or the absence of insecure defaults. This may include, for example (but not limited to), customizable firewall settings, options available for protecting sensitive information, and/or investigating user-controlled access control mechanisms.

The calculation may utilize data from at least one source, including, but not limited to Common Platform Enumerations (CPEs) 805, Product Manuals 815, Vendor Self-Attestation Data 825, and/or Vendor Size Data 830.

The number, type, arrangement, and order of components shown in FIG. 8 are merely illustrative. Components may be substituted, combined, omitted, rearranged, or supplemented in any manner without departing from the scope of the invention.

### 8.1) Product Security Configuration Data

Product Security Configuration Data 860 may represent information describing for example the security-related features and/or configuration options available within a vendor's product(s). Product Security Configuration Data 860 may be synthesized from at least one source, including, but not limited to, Unique Product(s)/Version(s) 835 and/or any number of Security Configuration Metrics 840. This data may be retrieved for example, but not limited to, through text extracted from vendor manuals and/or guides, analyzing product certifications, and/or compliance documentation, etc.

Unique Product(s)/Version(s) 835 may capture information pertaining to, but not limited to, the distinct and uniquely identifiable product versions. Versions may for example be supported, distributed, and/or sold by a vendor.

Emphasis may be placed on, but is not limited to, the most recent product version(s), as these may be recommended by the vendor through official communications such as blog posts, download portals, development roadmaps, changelogs, release notes, and/or marketing materials; actively supported through updates and/or security patches; and/or most commonly deployed in customer environments. Unique Product(s)/Version(s) 835 data may be obtained from Product Vulnerability Data 800, which may comprise one or more data sources cataloging product identifiers (which may be unique), including, but not limited to, Common Platform Enumerations (CPEs) 805. Product identifiers may include, but are not limited to, hash values that identify software versions, evaluating and/or comparing the similarity of binary code, extracting and/or storing version metadata, etc.

Security Configuration Metrics 840 may represent information describing for example the presence and/or implementation of key security-related product features. These features may include, but are not limited to, Use of Multi-Factor Authentication (MFA) 845, avoidance and/or Use of Default Passwords 850, Use of Encrypted Communications 855, general data encryption mechanisms, and/or secure authentication protocols, etc. These metrics may be extracted as Additional Data 810, which comprises Product Manuals 815 and/or other official and/or semi-official vendor documentation etc. Data extraction may be performed using one or more automated techniques, including, but not limited to, computer vision systems (for documents in image-based formats such as PDF, PNG, or JPG, etc.) and/or natural language processing (NLP) techniques (for documents in text-based formats such as plaintext, DOCX, and/or web-based content, etc.), data extraction from audio and/or video files, and/or other (comparable or differing) data parsing and/or analysis tools.

### 8.2) Vendor Normalization

Vendor Normalization 865 may involve any number of adjustments and/or calibrations of \Product Security Configuration Data 860 to account for differences (which may be contextual) among vendors, including but not limited to organizational size, market presence, product portfolio breadth, and/or overall exposure surface, etc. Vendor Normalization 865, in the context of the configurability sub-rating calculation, may be used to ensure equitable evaluation of vendors that may produce varying amounts of product documentation and/or provide differing levels of publicly available configuration information. These variations may arise from factors such as financial resources, workforce capacity, and/or product category and/or industry sector etc.

Vendor Normalization 865 may use Vendor Metadata 820, which may comprise one or more data sources including, but not limited to, Vendor Self-Attestation Data 825 and/or Vendor Size Data 830 to perform any number of adjustments and/or calibrations of the Product Security Configuration Data 860 including, but not limited to, incorporating product manuals supplied by a vendor that the initial data sources did not account for, accounting for smaller-sized vendors who may not have the financial resources to support robust product documentation, etc.

Vendor Normalization 865 of Product Security Configuration Data 860 may result in a complete Configurability Sub-Rating(s) 870.

### 9) Functional Diagram for Generic Sub-Rating Calculation

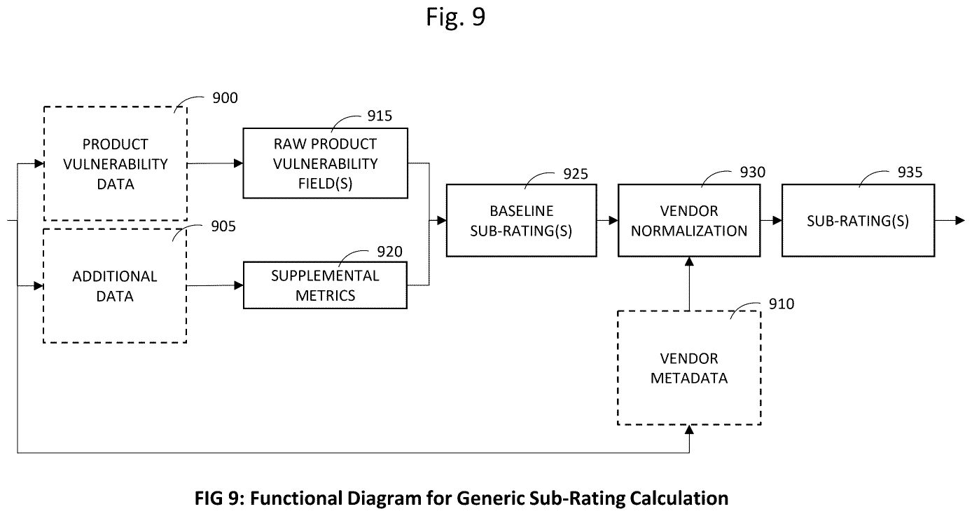

FIG. 9 illustrates an example for calculating a Generic and/or Abstract Sub-Rating(s) 935 in an example of the vendor cybersecurity rating system, which may comprise one or more of generalized data processing, generation, and/or computational steps. Generic and/or Abstract Sub-Rating(s) may describe, among other things, a generalized and/or abstract framework for sub-rating calculation that encompasses both the specific sub-ratings described herein (e.g., exploitability, remediability, severity, explainability, configurability, etc.) and/or other sub-ratings not explicitly detailed; all or most of which share certain attributes such as for example the use of comparable data sources, data flow methodologies, supplemental metrics, baseline sub-rating(s), and/or vendor normalization techniques etc. The calculation may utilize data from any number of sources, including, but not limited to, Product Vulnerability Data 900, Additional Data 905, and/or Vendor Metadata 910 etc., each serving as a generalized representation of the data sources employed by the more concrete sub-rating calculations. For example, in the context of FIG. 4, Product Vulnerability Data 900 corresponds to Common Vulnerabilities and Exposures (CVEs) 405, Additional Data 905 corresponds to Known Exploited Vulnerabilities 415, and Vendor Metadata 910 corresponds to Vendor Self-Attestation Data 425 and/or Vendor Size Data 430, etc.

The number, type, arrangement, and/or order of components in FIG. 9 may vary, and/or additional or fewer elements may be included without departing from the scope of the invention.

### 9.1) Baseline Sub-Ratings

Baseline Sub-Rating(s) 925 may represent information and/or data that may vary depending on the specific sub-rating being calculated. Baseline Sub-Rating(s) may assess one or more aspects of one or more vendor's and/or product's cybersecurity posture, performance, and/or practices etc. For example, in the context of FIG. 4, the Baseline Sub-Rating(s) 925 correspond to Historic Exploitation Data 445. Baseline Sub-Rating(s) 925 may be synthesized from at least on source, including, but not limited to, Raw Product Vulnerability Field(s) 915 and/or Supplemental Metrics 920.

Raw Product Vulnerability Field(s) 915 may capture information extracted from one or more vulnerability data sources, such as, but not limited to, Common Vulnerabilities and Exposures (CVE), Common Platform Enumeration (CPE), VulnDB data, ExploitDB data, OSV data, and/or vendor-issued advisory, etc. Vendor-issued advisory may include, but is not limited to, specific data fields such as vulnerability identifiers, descriptions, severity levels, product names, and/or version numbers etc. Raw Product Vulnerability Field(s) may include derived and/or aggregated data computed across at least one CVE and/or CPE record. For example, in the context of FIG. 4, a Known-to-Exist Vulnerability Set 435 may be derived solely from CVE 405 data. Raw Product Vulnerability Field(s) 915 may be obtained from one or more data sources, for example, but not limited to, from Product Vulnerability Data 900 (e.g., CVEs 405 as shown in FIG. 4, etc.).

Supplemental Metrics 920 may represent auxiliary and/or contextual data designed to augment and/or enhance the Raw Product Vulnerability Field(s) 915, thereby for example improving the relevance and/or interpretability of the information for cybersecurity vendor and/or product rating purposes. Supplemental metrics may be derived from data sources external to those comprising Product Vulnerability Data 900. For example, in FIG. 4, the Known Exploited Vulnerability Metrics 440 may be derived from KEVs 415. Supplemental Metrics 920, which may be included with their constituent data sources, may exist in a variety of formats, for example including but not limited to, structured databases, spreadsheets, text documents, and/or unstructured formats such as PDFs and/or web-based repositories etc.

### 9.2) Vendor Normalization

Vendor Normalization 930 may involve one or more adjustments and/or calibrations of the Baseline Sub-Rating(s) 925 to account for (e.g., contextual) differences among vendors, including, but not limited to, organizational size, market presence, product portfolio diversity, and/or overall exposure surface etc. The specific purpose of Vendor Normalization 930 may vary depending on the concrete sub-rating calculation. Vendor Normalization 930 may aim to ensure equitable evaluation of vendors exhibiting distinct, outlier, and/or otherwise atypical characteristics that may necessitate reweighting and/or adjustment of their cybersecurity rating. For example, in FIG. 4, Vendor Normalization 450 may ensure for example fair assessment of vendors whose more widely adopted products may be inherently targeted more frequently by malicious actors.

Vendor Normalization 930 may rely on at least one source of Vendor Metadata 910. Vendor Metadata 910 may represent data required to perform normalization and/or may include, but is not limited to, information describing vendor size, industry sector, financial standing, and/or quantity or diversity of supported products etc. For example, in FIG. 4, Vendor Metadata 910 may correspond to Vendor Self-Attestation Data 425 and/or Vendor Size Data 430.

Vendor Self-Attestation Data 810 may be a (e.g., common, though not universal) component of Vendor Metadata 910. Vendor Self-Attestation Data may include, but is not limited to, compliance documentation, vulnerability assessment results, and/or other materials voluntarily submitted by vendors to enhance the accuracy of their respective rating(s) and/or sub-rating(s). Vendor Self-Attestation Data 810 may enable vendors to contest, clarify, and/or otherwise influence their rating outcomes by providing substantiating evidence. This data may be incorporated into a vendor cybersecurity rating system through any number of channels, including, but not limited to, a web-based portal, application programming interface (API) requests, electronic mail submissions, and/or direct developer interactions etc.

Vendor Normalization 930 of Baseline Sub-Rating(s) 925 may result in a complete Sub-Rating(s) 935. For example, in FIG. 4, Vendor Normalization 450 of Historic Exploitation Data 445 may result in a complete Exploitability Sub-Rating 455.

### 9.3) Other Example Sub-Ratings

Generic and/or Abstract Sub-Rating(s) 935 may encompass both the specific sub-ratings described herein (e.g., exploitability, remediability, severity, explainability, configurability, etc.) and/or other potential sub-ratings. Examples may include, but are not limited to:
an AI-focused sub-rating which may incorporate data related to, but not limited to, vendors and/or products involving artificial intelligence (AI) and/or machine learning (ML) models, and/or systems that integrate such models. An AI-focused sub-rating may assess AI-specific security dimensions, such as, but not limited to, susceptibility to adversarial attacks, robustness against malicious input, compliance with AI software bill of materials (AI SBOM) formats, model interpretability, data poisoning risk, performance degradation patterns, and/or potential intellectual property violations etc.; and/or
a compliance-focused sub-rating that may determine how well one or more vendors and/or products aligns with one or more compliance, guidance, best practices, and/or legal frameworks etc. Determining a compliance-focused sub-rating may include evaluating a vendor's and/or product's commitment to intellectual property rights, data privacy laws, and/or other relevant (e.g., legal) frameworks etc. For example, a sub-rating may determine how well a vendor's cybersecurity practices align with NIST SP 800-53.
a binary executable-focused sub-rating which may incorporate data related to, but not limited to, vendor and/or product Software Bill of Materials (SBOM) disclosures and/or the results of static and/or dynamic binary analysis etc. It may evaluate the accuracy, availability and/or integrity etc. of vendor-provided SBOM information by comparing declared dependencies and/or libraries against those identified through automated binary inspection and/or reverse engineering.

### 10) Component(s) of UI/UX for Vendor Cybersecurity Ranking

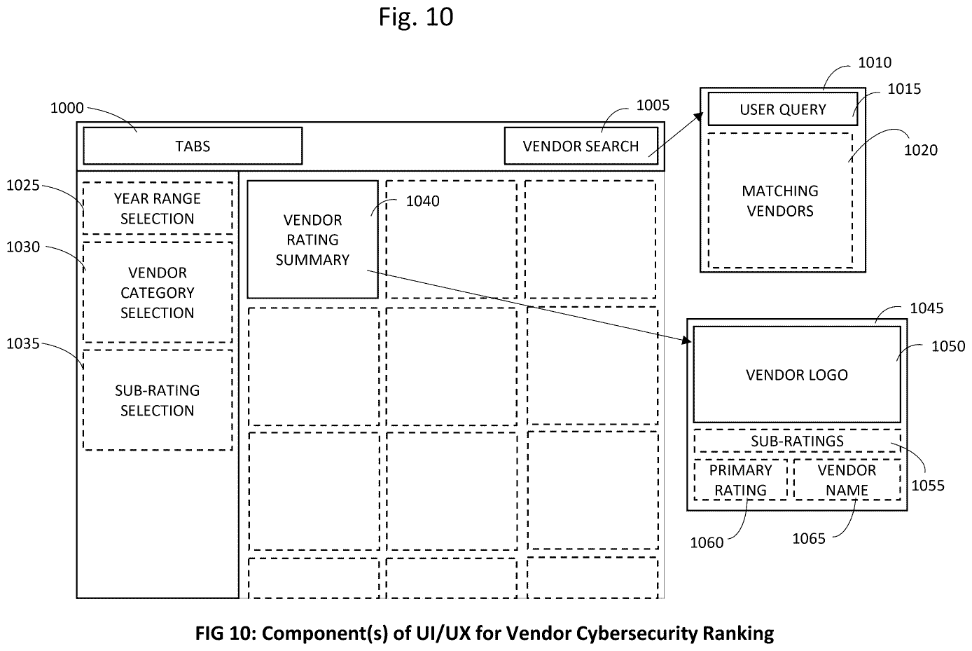

FIG. 10 illustrates an exemplary user interface (UI) for, for example but not limited, displaying the ranking and/or ordering of a subset and/or the complete set of rated vendors within an example of the vendor cybersecurity rating system. The interface may support any number of operations. Such operations include, but are not limited to, initiating physical or virtual processes, manipulating displayed information (e.g., filtering, sorting, searching and/or pruning, etc.), and/or displaying data, etc. The UI may comprise at least one interactive element, including, but not limited to, a Tabs 1000, Vendor Search Components (1005, 1010, 1015, 1020), Vendor Filter Options (1025, 1030, 1035), and/or one or more Vendor Rating Summaries (1040, 1045, 1050, 1055, 1060, 1065).

The number, type, arrangement, and order of components shown in FIG. 10 are merely illustrative. Components may be substituted, combined, omitted, rearranged, or supplemented in any manner without departing from the scope of the invention.

### 10.1) Tabs

Tabs 1000 may provide a visual indication that a vendor cybersecurity rankings interface is active. Any number of indications may distinguish the rankings interface from other interface regions or modes, including but not limited to explanation views, detail views, comparison views, filtering views, sorting views, dashboard views, administrative views, analytics views, etc., and any other page, tab, screen, or UI state etc. that the system may present.

Tabs 1000 may serve as an interactive element that enables user actions including, but not limited to, page navigation (e.g., returning to the vendor rankings view from another page, etc.) and/or page refreshing (e.g., reloading the current vendor rankings display to reflect updated data and/or filter selections, etc.).

### 10.2) Vendor Search

A Vendor Search Bar 1005 may enable users to locate specific vendors that have been evaluated and/or rated within the vendor cybersecurity rating system. Interaction with a Vendor Search Bar 1005 may trigger the display of an associated Vendor Search Display 1010, which may appear, for example, as a dropdown menu, popup window, and/or modal interface element etc.

A Vendor Search Display 1010, when active, may present a User Query 1015, which comprises one or more of the user's search query inputs (e.g., text entered into a Vendor Search Bar 1005 before and/or during interaction, etc.) along with Matching Vendors 1020, which comprise corresponding search results, including but not limited to vendor names, unique identifiers, and/or other descriptive text matching the user's query etc. Each displayed vendor result may be interactive, allowing the user to perform one or more actions, including, but not limited to, selecting a vendor entry to navigate to the corresponding vendor-specific page and/or rating view within the system.

### 10.3) Vendor Filter Options

A Year Range Selection 1025 component(s) may enable users to for example specify a particular point in time (e.g., day, month, year, etc.) and/or a range of time (e.g., at least one day, month, year, etc.) to refine the data presented within the vendor cybersecurity rating system. Adjusting a Year Range Selection 1025 may, among other effects, modify (e.g., filter) the vendors displayed, their associated ratings and/or sub-ratings, their relative rankings, and/or the corresponding visual and/or computational representations etc. Filtering operations may limit and/or recalculate displayed results to include data generated, updated, and/or applicable within the specified time period and/or range.

A Vendor Category Selection 1030 component(s) may enable users to specify one or more vendor and/or product categories (e.g., embedded systems, operating systems, web applications, medical devices, etc.) to refine the information displayed within the vendor cybersecurity rating system. Adjusting a Vendor Category Selection 1030 may, among other effects, modify the vendors presented, their corresponding ratings and/or sub-ratings, their relative rankings, and/or associated visual and/or computational representations etc. Such filtering operations may restrict and/or recalculate the displayed results to include vendors and/or products that fall within the selected category and/or categories.

A Sub-Rating Selection 1035 component may enable users to specify one or more sub-ratings (e.g., exploitability, remediability, severity, etc.) to further refine the information displayed within the vendor cybersecurity rating system. Adjusting a Sub-Rating Selection 1035 may, among other effects, alter the vendors displayed, their associated ratings and/or sub-ratings, their relative rankings, and/or the corresponding visual and/or computational outputs etc. Such filtering operations may constrain and/or recalculate the displayed results to emphasize the selected sub-rating(s), for example, by assigning higher weighting factors to the chosen sub-ratings within the primary rating calculation and/or by limiting the computation of the primary rating to include the specified sub-rating categories.

### 10.4) Vendor Rating Summaries

A Vendor Rating Summary 1040 may present Vendor Rating Summary Content 1045 associated with a rated vendor, including, but not limited to, a Vendor Logo 1050, Vendor Name 1065, Primary Rating 1060, and/or one or more Sub-Ratings 1055, which may be displayed, among other ways, numerically, through color-coding, and/or via proportional visual indicators (e.g., weighted bars, etc.). The Vendor Rating Summary 1040 may serve as an interactive element, allowing users to perform actions such as, but not limited to, selecting and/or clicking the summary to navigate to a detailed vendor rating view and/or additional information page.

At least one Vendor Rating Summaries 1040 may be displayed in a defined order (e.g., ascending or descending) corresponding to vendor ranking and/or rating hierarchy (e.g., highest to lowest primary rating, lowest to highest specific sub-rating, etc.). The Vendor Rating Summaries 1040 may be presented in any number of display formats, including, but not limited to, table layouts, grid views, and/or list arrangements.

### 11) Component(s) of UI/UX for Vendor Cybersecurity Rating

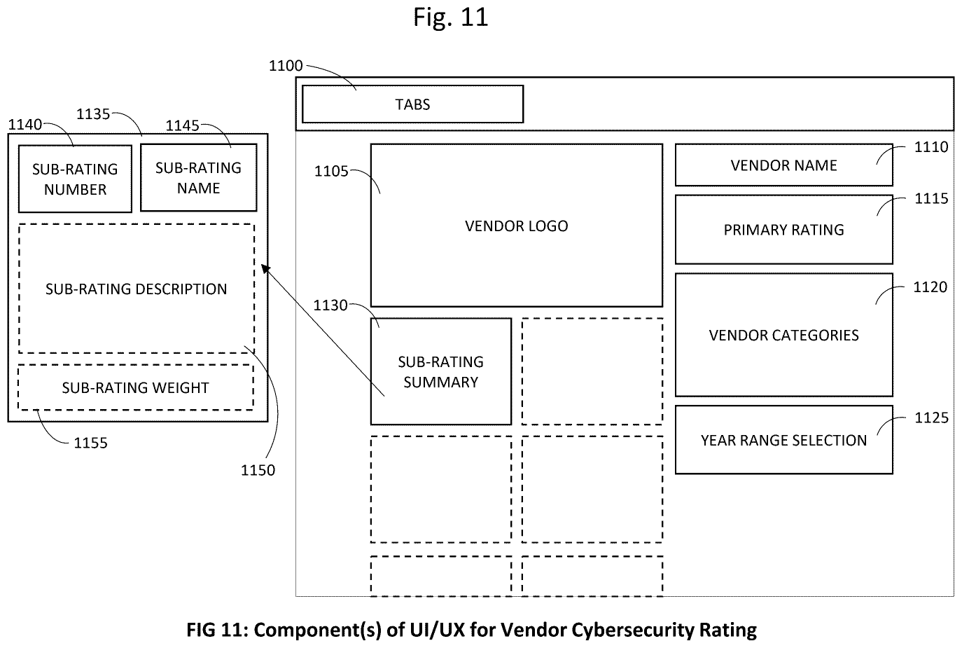

FIG. 11 illustrates an exemplary user interface (UI) for displaying for example a rating, sub-ratings, and/or other relevant information associated with a vendor evaluated by an example of the vendor cybersecurity rating system. The interface may support operations including, but not limited to, filtering, sorting, searching, and/or pruning data and/or computations etc. associated with a vendor's rating and/or sub-ratings, thereby enabling, for example, dynamic modification of the displayed results. The UI may comprise one or more potentially interactive elements, including, but not limited to, Tabs 1100, Vendor Information (1105, 1110, 1115, 1120), Filter Options 1125, and one or more Sub-Rating Summaries (1130, 1135, 1140, 1145, 1150, 1155).

The number, type, arrangement, and order of components shown in FIG. 11 are merely illustrative. Components may be substituted, combined, omitted, rearranged, or supplemented in any manner without departing from the scope of the invention.

### 11.1) Tabs

Tabs 1100 may visually indicate a user is currently viewing a vendor cybersecurity rating interface, as opposed to an alternative page, tab, and/or screen such as, but not limited to, a rating explanation view and/or a vendor ranking view. Tabs 1100 may serve as an interactive element that enables user actions including, but not limited to, page navigation (e.g., returning to the vendor rating view from another page, etc.) and/or page refreshing (e.g., reloading the current vendor rating display to reflect updated data and/or filter selections, etc.).

### 11.2) Vendor Information

The Vendor Logo 1105 visually represents a vendor through an image and/or graphical mark. Relevant formats include, but are not limited to, PNG, SVG, JPG, WEBP, etc.

The Vendor Name 1110 displays the textual name of the vendor.

The Primary Rating 1115 presents the vendor's primary cybersecurity rating, which may be expressed, among other ways, numerically, graphically, and/or in addition to its constituent sub-ratings, which themselves may be expressed, among other ways, through color-coding, and/or via proportional visual indicators (e.g., weighted bars, etc.) etc.

The Vendor Categories 1120 identifies any number of vendor and/or product categories associated with the vendor (e.g., embedded systems, operating systems, industrial control software, medical devices, etc.).

### 11.3) Filter Options

Filter options include but are not limited to Year Range Selection 1125.

Year Range Selection 1125 enables users to, among other things, specify a particular point in time (e.g., day, month, year, etc.) and/or a range of time (e.g., at least one day, month, year, etc.), for example to refine the data used to calculate the rating and/or sub-ratings associated with the vendor being viewed. Year Range Selection 1125 may limit and/or recalculate displayed results to include data generated, updated, and/or applicable within the specified time period and/or range, which may alter the viewed vendors presented rating and/or sub-ratings.

### 11.4) Sub-Rating Summaries

A Sub-Rating Summary 1130 presents Sub-Rating Summary Content 1135 associated with one of the viewed vendor's sub-ratings, including, but not limited to, the Sub-Rating Name 1145, Sub-Rating Number 1140, Sub-Rating Description 1150, and/or corresponding Sub-Rating Weight 1155. The sub-rating description, if included, may be dynamically generated and/or context-dependent, varying based on factors such as the specific vendor being viewed, the sub-rating category, the sub-rating score, and/or other relevant parameters etc.

At least one Sub-Rating Summary 1130 may be displayed in a defined order (e.g., ascending or descending) corresponding to sub-rating weights and/or scores (e.g., highest to lowest sub-rating weight, lowest to highest sub-rating score, etc.). Sub-Rating Summaries 1130 may be presented in a variety of display formats, including, but not limited to, tabular layouts, grid views, and/or list arrangements etc.

### 12) Component(s) of UI/UX for Vendor Cybersecurity Explanation

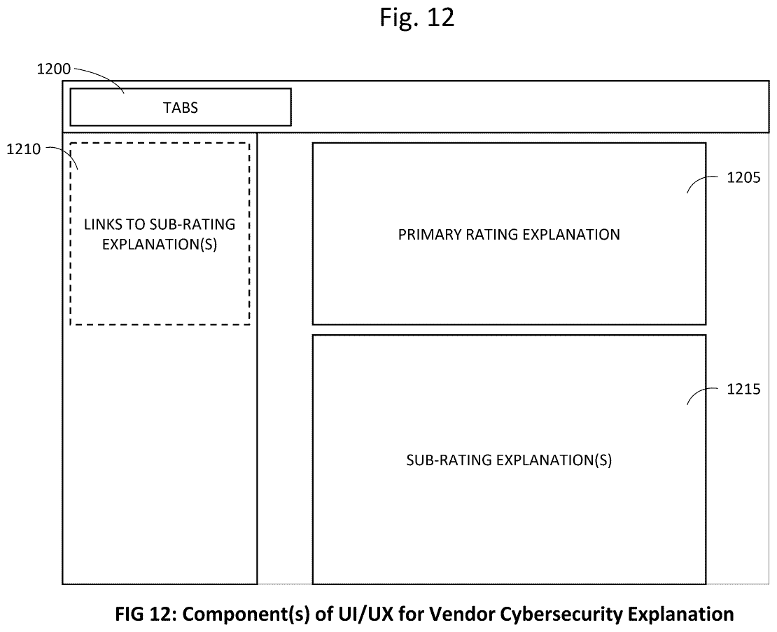

FIG. 12 illustrates an exemplary user interface (UI) configured to display any number of (e.g., written) explanations of the rating and/or sub-rating methodologies and/or calculations utilized within an example of the vendor cybersecurity rating system. Explanations may comprise outputs and/or components of a reproducibility engine, which may include, but is not limited to, descriptions of mathematical operations, analytical processes, data sources employed, and/or weighting and/or aggregation methods etc. The UI may comprise any number of interactive elements, including, but not limited to, Tabs 1200, one or more Primary Rating Explanation(s) 1205, and Sub-Rating Explanation(s) (1210, 1215) etc.

The number, type, arrangement, and order of components shown in FIG. 12 are merely illustrative. Components may be substituted, combined, omitted, rearranged, or supplemented in any manner without departing from the scope of the invention.

### 12.1) Tabs

Tabs 1200 may visually indicate that the user is currently viewing a vendor cybersecurity rating explanation page, as opposed to an alternative page, tab, and/or screen such as, but not limited to, a vendor ranking view and/or a specific vendor rating view. Tabs 1200 may also serve as an interactive element that enables user actions including, but not limited to, page navigation (e.g., returning to the rating explanation view from another page, etc.) and/or page refreshing etc.

### 12.2) Primary Rating(s)

A Primary Rating Explanation 1205 may provide any number of (e.g., written) descriptions detailing methodologies and/or calculations employed by an example of the vendor cybersecurity rating system to produce a vendor's primary rating. Explanations may include, but are not limited to, discussions of aggregation techniques, weighting models, statistical and/or mathematical operations, and/or other computational processes etc. Primary Rating Explanation 1205 may primarily focus on sub-rating aggregation methods used to generate the overall vendor cybersecurity rating, rather than any one specific sub-rating.

In an example, determining a Primary Rating Explanation 1205 may include a dynamic process between a user and vendor cybersecurity rating system. Determining a Primary Rating Explanation may comprise providing a chat user interface for a user to describe a rating and/or sub-rating in natural language. Determining a Primary Rating Explanation may include providing sliders that let users rank how they value aspects of a vendor and/or sub-ratings. Determining a Primary Rating Explanation may include providing text boxes where users can rank how they value aspects of a vendor and/or sub-ratings. A vendor cybersecurity rating system may use value data provided by a user to calculate a primary rating and/or explanation.

### 12.3) Sub-Rating(s)

Sub-Rating Explanation(s) 1215 may comprise any number of written descriptions detailing methodologies and/or calculations utilized by an example of the vendor cybersecurity rating system to produce individual sub-ratings (e.g., exploitability, remediability, severity, explainability, configurability, etc.). Explanations may include, but are not limited to, discussions of aggregation techniques, weighting models, statistical and/or mathematical operations, normalization procedures, and/or other computational methods. Sub-Rating Explanation(s) 1215 may focus on specific details associated with the calculating of each sub-rating, rather than an aggregation calculation that combine them into a primary rating.

Links to Sub-Rating Explanation(s) 1210 may consist of any number of interactive elements that enable users to navigate directly to the relevant sub-rating explanation sections. Links may appear as, but are not limited to, buttons, hyperlinks, sub-tabs, and/or similar interface elements etc. and may dynamically highlight and/or scroll to corresponding Sub-Rating Explanation 1215 content when selected.

### 13) Flowchart for UI/UX

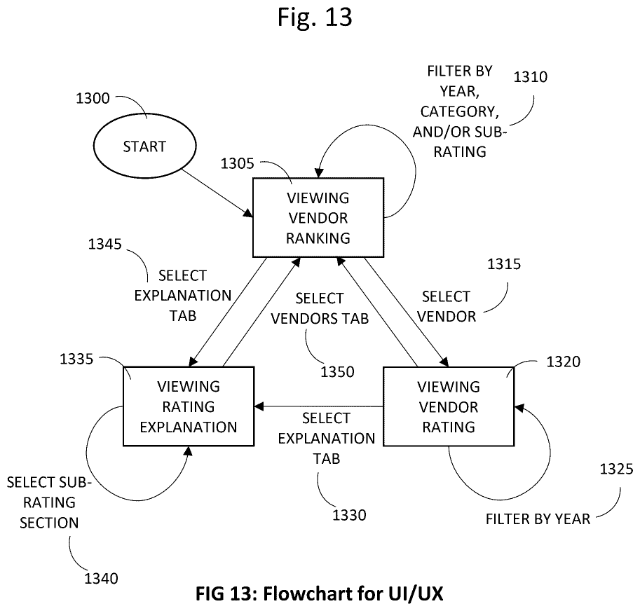

FIG. 13 illustrates a flowchart representing an example user experience (UX) of an example of the vendor and product cybersecurity rating system. The UX encompasses, but is not limited to, interactions with any number of user interface (UI) components and/or their corresponding features and/or functionalities. UI components include, for example, Viewing Vendor Ranking 1305, Viewing Vendor Rating 1320, and/or Viewing Rating Explanations 1335, as well as transitions and/or interactions between these components (1310, 1315, 1325, 1330, 1340, 1345, 1350), such as component swapping and/or dynamic updates triggered by changes in search, sorting, and/or filtering criteria. The elements depicted in the exemplary UX flowchart correspond to and/or reference the specific UI components described herein; for instance, Viewing Vendor Ranking 1305 corresponds to FIG. 10, Viewing Vendor Rating 1320 corresponds to FIG. 11, Viewing Rating Explanations 1335 corresponds to FIG. 12, etc. In other examples of the flowchart depicted in FIG. 13, vendors may be other entities, products, AI models, etc.

The number, type, arrangement, and order of components shown in FIG. 13 are merely illustrative. Components may be substituted, combined, omitted, rearranged, or supplemented in any manner without departing from the scope of the invention.

### 13.1) Viewing Vendor Ranking

Viewing Vendor Ranking 1305 may involve, but is not limited to, the presentation (e.g., displaying) of rated vendors that have been ranked and/or ordered according to their respective rating outcomes (e.g., highest to lowest rating, lowest to highest rating, highest to lowest sub-rating, lowest to highest sub-rating, etc.). As illustrated in FIG. 13, users interacting with a Viewing Vendor Ranking 1305 interface may perform one or more actions, including, but not limited to: Select Vendor 1315 to initiate Viewing Vendor Rating 1320; Select Explanation Tab 1345 to initiate Viewing Rating Explanation 1335; and/or Filter by Year, Category, and/or Sub-Rating 1310 to dynamically refresh a Viewing Vendor Ranking 1305 interface, resulting in one or more changes to the displayed vendors and/or their ordering (e.g., updating display order, modifying which vendors are visible, etc.).

As illustrated in FIG. 13, the example UX may Start 1300 at a Viewing Vendor Ranking 1305 interface, which may for example be considered as a home page and/or landing page (e.g., in the context of a website, web application, etc.).

### 13.2) Viewing Vendor Rating

Viewing Vendor Rating 1320 may involve, but is not limited to, the presentation (e.g., displaying) of information associated with a single rated vendor, including, but not limited to, the vendor's name, logo, product categories, primary cybersecurity rating, and/or one or more constituent sub-ratings etc. Each sub-rating may be accompanied by its respective score, descriptive label, explanation, and/or weighting factor etc. As illustrated in FIG. 13, users interacting with a Viewing Vendor Rating 1320 interface may perform any number of actions. Actions may include, but are not limited to: Select Vendors Tab 1350 to initiate Viewing Vendor Ranking 1305; Select Explanation Tab 1330 to initiate Viewing Rating Explanation 1335; and/or Filter by Year 1325 to apply one or more filters, such as a temporal filter (e.g., year and/or month range, etc.). Application of such filters may for exaple dynamically refresh the Viewing Vendor Rating 1320 interface, resulting for example, but not limited to, in an update(s) to the displayed vendor data, including modifications to sub-rating scores, weighting, and/or visual presentation, etc.

In an example of the vendor cybersecurity rating system, users may interact with a vendor rating through a chatbot. Through interaction, a cybersecurity rating system may provide any number of ratings dynamically in response. A user may select criteria, which may dynamically modify the score. For example, criteria may be used to rule out specific sub-ratings and/or provide a higher weight to at least one sub-rating.

### 13.3) Viewing Vendor Explanation

Viewing Rating Explanation 1335 may involve, but is not limited to, the presentation (e.g., displaying) of written explanations (which may be detailed) pertaining to a calculation of ratings and/or sub-ratings, including, but not limited to, descriptions of any number of associated methodologies, data sources, weighting schemes, and/or computational logic etc. As illustrated in FIG. 13, users interacting with the Viewing Rating Explanation 1335 interface may perform any number of actions, including, but not limited to: Select Vendors Tab 1350 to return to Viewing Vendor Ranking 1305, and/or Select Sub-Rating Section 1340 (e.g., via hyperlink, sub-tab, and/or similar interactive element, etc.) to dynamically scroll and/or navigate a user to a corresponding explanatory subsection within a Viewing Rating Explanation 1335 interface, thereby displaying information related to a selected sub-rating's computation, methodology, and/or data provenance.

What is claimed is:

1. A computer-implemented method for rating the cybersecurity of vendors and products, the method comprising:
loading, via the processor, from a data storage, a network communication, or via a user entry through a user interface, at least one input data from at least one data source pertaining to vendor or product cybersecurity;
selecting, via the processor, at least one sub-rating calculation template from a preconfigured set of sub-rating calculation templates corresponding to the input data;
calculating, via the processor, at least one vendor or product sub-rating score, by applying at least one sub-rating calculation template to the at least one input data;
generating, via the processor, at least one vendor or product primary rating score, by applying at least one aggregation template to the at least one vendor or product sub-rating score;
storing, via the processor, in a memory storage, the at least one vendor or product primary rating score, the at least one vendor or product sub-rating score, and the input data;
ranking, via the processor, the at least one vendor or product primary rating score among at least one other vendor or product primary rating score using at least one ranking strategy;
distributing, via a computer network, at least one vendor or product rating result to at least one data sink, or displaying, via the processor, the at least one vendor or product rating result in a user interface.

2. The method according to claim 1, wherein the at least one input data comprises at least one of vendor size, organizational structure, industry sector, financial standing, product portfolio breadth, quantity or diversity of supported products, software bill of materials (SBOM) data, or vulnerability data comprising Common Weakness Enumerations (CWEs) fields, Common Vulnerabilities and Exposures (CVEs) fields, Common Platform Enumerations (CPEs) fields, and vulnerability analysis results including vulnerability identifiers, descriptions, severity levels, exploitability likelihood, and associated remediation actions.

3. The method according to claim 1, wherein the at least one input data is pre-processed through a variety of techniques, including structuring of unstructured data, data extraction from product manuals or product documentation, or periodic web-scraping of relevant data sources; wherein data extraction from product manuals comprises at least one of computer vision systems for documents in image-based formats comprising at least one of PDF, PNG, or JPG or natural language processing (NLP) techniques for documents in text-based formats comprising at least one of plaintext, DOCX, or web-based content.

4. The method according to claim 1, wherein the at least one data source comprises at least one of publicly available vulnerability databases, privately available vulnerability databases, security advisories, the National Vulnerability Database (NVD), Common Vulnerabilities and Exposures (CVEs), Common Platform Enumerations (CPEs), VulnDB data, ExploitDB data, Open Source Vulnerability (OSV) data, vendor-issued advisories, Known Exploited Vulnerabilities (KEV) Catalog, software or hardware release notes, vendor blog posts, news articles, financial data, vulnerability disclosure program (VDP) data, bug-bounty program data, product manuals, product documentation, security forum data, or vendor self-attestation data; wherein the vendor self-attestation data comprises cybersecurity compliance attestations, security certifications, documentation of vulnerability remediation, incident response processes, or proof of adherence to secure development frameworks.

5. The method according to claim 1, wherein the at least one sub-rating calculation template comprises at least one of an exploitability sub-rating measuring the likelihood of product vulnerabilities being exploited, a remediability sub-rating measuring the timeliness and quality of vulnerability mitigation, a severity sub-rating assessing historical vulnerability severity and impact, an explainability sub-rating evaluating the readability, clarity, and transparency of vendor security communications, a configurability sub-rating assessing security configuration options available to customers, sub-ratings related to AI model robustness, binary software analysis, supply chain integrity, or other cybersecurity-related factors, or an abstract sub-rating process; wherein the abstract sub-rating process comprises the synthesis of raw product vulnerability fields from product vulnerability data with supplemental metrics from additional data to create baseline sub-ratings or vendor normalization using vendor metadata on baseline sub-ratings to create final sub-ratings.

6. The method according to claim 1, wherein calculating includes explainability and transparency metrics and visualizations to provide reasoning behind its decisions including detailed explanations of data sources and methodologies used in calculations, explanations of how each vendor's input data contributed to their overall score, visualization tools that display the contribution of each factor to the overall score, confidence intervals or uncertainty estimates for sub-ratings, audit trails or logs of all inputs, outputs, and decision-making processes, explanations of why and how the score changed over time, or interactive dashboards that allow users to explore and drill down into specific scores.

7. The method according to claim 1, wherein the at least one vendor or product sub-rating score comprises a calculated numerical or categorical value representing performance in a specific cybersecurity domain or metric category; wherein the metric category comprises at least one of exploitability, remediability, severity, explainability, configurability, AI model robustness, binary software analysis, or abstract.

8. The method according to claim 1, wherein the at least one vendor or product primary rating score comprises a calculated numerical or categorical value representing an aggregate cybersecurity posture for a vendor or product, derived from aggregations of sub-ratings, and wherein said primary vendor rating is dynamically updated upon changes in data sources or vendor submissions.

9. The method according to claim 1, wherein the at least one aggregation template comprises applying at least one statistical or computational model including weighted averaging, unweighted averaging, or machine learning models trained to produce a composite primary rating; wherein said aggregating may dynamically re-weight sub-ratings based on vendor metadata including vendor size, industry classification, or historical vulnerability exposure.

10. The method according to claim 1, wherein the at least one ranking strategy comprises at least one of leaderboards ranking top-performing vendors, ranking tables displaying vendor performance, rankings grids comparing vendor performance across one or more dimensions, ranking graphs comparing vendor rating performance over time; and wherein rankings allow for the filtering, sorting, and searching of vendors and products based on year-ranges, product and vendor categories, or specific sub-ratings.

11. The method according to claim 1, wherein the at least one vendor or product rating result comprises automated guided feedback to improve a user's cybersecurity posture, an interactive chatbot, information presented on an accessible webpage, or individualized automated email communications.

12. The method according to claim 1, wherein the at least one vendor or product rating result comprises information to help a vendor improve their own ratings, including suggesting secure product development techniques to reduce recurring classes of vulnerabilities, suggesting more efficient product management strategies to improve patch timelines, suggesting how to write missing documentation for specific product categories, suggesting re-phrasing of difficult to understand syntax or semantics in vendor communications, or providing adaptive feedback informed by insights derived from other vendors whose ratings have improved in response to similar recommendations; wherein the adaptive feedback may further refine its recommendations over time through a feedback-loop that analyzes historical correlations between prior feedback actions and subsequent rating improvements.

13. The method according to claim 1, wherein the at least one vendor or product rating result comprises information to inform an end-user's purchase decisions and improve their cybersecurity posture, including examination of a vendor's risk exposure across its entire supply chain network, including original equipment manufacturers (OEMs), component suppliers, and other third-party vendors, comparative ratings of competing vendors, rankings for specific categories of vendors, risk-based approval of vendors, or mapping of vendors to the end-user's specific requirements or compliance and legal requirements.

14. The method according to claim 1, wherein the at least one data sink comprises integrations with a variety of platforms, including third-party software, systems, search engines, browser extensions, online marketplaces and storefronts, as well as Software Bills of Materials (SBOMs), Artificial Intelligence Bills of Materials (AIBOMs), DevSecOps pipelines, Machine Learning Operations (MLOps) pipelines, compliance mapping, API Continuous Integration/Continuous Deployment, displayed on a tablet device, or available from a QR code, barcode, or NFC tag on the vendor's device.

15. The method according to claim 1, wherein displaying comprises at least one of numerical, graphical, textual, or color-coordinated representation of ratings; graphs of how ratings change over time; user interface components displaying vendor ratings and associated information, including logos, categories, and score distributions; wherein the user interface allows for the filtering, sorting, searching, or time-range selection of ratings; and wherein vendor-specific pages display rating explanations, data provenance, and improvement recommendations.

16. A computer-implemented system for rating the cybersecurity of vendors and products, the system comprising:
loading, via the processor, from a data storage, a network communication, or via a user entry through a user interface, at least one input data from at least one data source pertaining to vendor or product cybersecurity;
selecting, via the processor, at least one sub-rating calculation template from a preconfigured set of sub-rating calculation templates corresponding to the input data;
calculating, via the processor, at least one vendor or product sub-rating score, by applying at least one sub-rating calculation template to the at least one input data;
generating, via the processor, at least one vendor or product primary rating score, by applying at least one aggregation template to the at least one vendor or product sub-rating score;
storing, via the processor, in a memory storage, the at least one vendor or product primary rating score, the at least one vendor or product sub-rating score, and the input data;
ranking, via the processor, the at least one vendor or product primary rating score among at least one other vendor or product primary rating score using at least one ranking strategy;
distributing, via a computer network, at least one vendor or product rating result to at least one data sink, or displaying, via the processor, the at least one vendor or product rating result in a user interface.

17. The system according to claim 16, wherein the at least one input data comprises at least one of vendor size, organizational structure, industry sector, financial standing, product portfolio breadth, quantity or diversity of supported products, software bill of materials (SBOM) data, or vulnerability data comprising Common Weakness Enumerations (CWEs) fields, Common Vulnerabilities and Exposures (CVEs) fields, Common Platform Enumerations (CPEs) fields, and vulnerability analysis results including vulnerability identifiers, descriptions, severity levels, exploitability likelihood, and associated remediation actions.

18. The system according to claim 16, wherein the at least one input data is pre-processed through a variety of techniques, including structuring of unstructured data, data extraction from product manuals or product documentation, or periodic web-scraping of relevant data sources; wherein data extraction from product manuals comprises at least one of computer vision systems for documents in image-based formats comprising at least one of PDF, PNG, or JPG or natural language processing (NLP) techniques for documents in text-based formats comprising at least one of plaintext, DOCX, or web-based content.

19. The system according to claim 16, wherein the at least one data source comprises at least one of publicly available vulnerability databases, privately available vulnerability databases, security advisories, the National Vulnerability Database (NVD), Common Vulnerabilities and Exposures (CVEs), Common Platform Enumerations (CPEs), VulnDB data, ExploitDB data, Open Source Vulnerability (OSV) data, vendor-issued advisories, Known Exploited Vulnerabilities (KEV) Catalog, software or hardware release notes, vendor blog posts, news articles, financial data, vulnerability disclosure program (VDP) data, bug-bounty program data, product manuals, product documentation, security forum data, or vendor self-attestation data; wherein the vendor self-attestation data comprises cybersecurity compliance attestations, security certifications, documentation of vulnerability remediation, incident response processes, or proof of adherence to secure development frameworks.

20. The system according to claim 16, wherein the at least one sub-rating calculation template comprises at least one of an exploitability sub-rating measuring the likelihood of product vulnerabilities being exploited, a remediability sub-rating measuring the timeliness and quality of vulnerability mitigation, a severity sub-rating assessing historical vulnerability severity and impact, an explainability sub-rating evaluating the readability, clarity, and transparency of vendor security communications, a configurability sub-rating assessing security configuration options available to customers, sub-ratings related to AI model robustness, binary software analysis, supply chain integrity, or other cybersecurity-related factors, or an abstract sub-rating process; wherein the abstract sub-rating process comprises the synthesis of raw product vulnerability fields from product vulnerability data with supplemental metrics from additional data to create baseline sub-ratings or vendor normalization using vendor metadata on baseline sub-ratings to create final sub-ratings.

21. The system according to claim 16, wherein calculating includes explainability and transparency metrics and visualizations to provide reasoning behind its decisions including detailed explanations of data sources and methodologies used in calculations, explanations of how each vendor's input data contributed to their overall score, visualization tools that display the contribution of each factor to the overall score, confidence intervals or uncertainty estimates for sub-ratings, audit trails or logs of all inputs, outputs, and decision-making processes, explanations of why and how the score changed over time, or interactive dashboards that allow users to explore and drill down into specific scores.

22. The system according to claim 16, wherein the at least one vendor or product sub-rating score comprises a calculated numerical or categorical value representing performance in a specific cybersecurity domain or metric category; wherein the metric category comprises at least one of exploitability, remediability, severity, explainability, configurability, AI model robustness, binary software analysis, or abstract.

23. The system according to claim 16, wherein the at least one vendor or product primary rating score comprises a calculated numerical or categorical value representing an aggregate cybersecurity posture for a vendor or product, derived from aggregations of sub-ratings, and wherein said primary vendor rating is dynamically updated upon changes in data sources or vendor submissions.

24. The system according to claim 16, wherein the at least one aggregation template comprises applying at least one statistical or computational model including weighted averaging, unweighted averaging, or machine learning models trained to produce a composite primary rating; wherein said aggregating may dynamically re-weight sub-ratings based on vendor metadata including vendor size, industry classification, or historical vulnerability exposure.

25. The system according to claim 16, wherein the at least one ranking strategy comprises at least one of leaderboards ranking top-performing vendors, ranking tables displaying vendor performance, rankings grids comparing vendor performance across one or more dimensions, ranking graphs comparing vendor rating performance over time; and wherein rankings allow for the filtering, sorting, and searching of vendors and products based on year-ranges, product and vendor categories, or specific sub-ratings.

26. The system according to claim 16, wherein the at least one vendor or product rating result comprises automated guided feedback to improve a user's cybersecurity posture, an interactive chatbot, information presented on an accessible webpage, or individualized automated email communications.

27. The system according to claim 16, wherein the at least one vendor or product rating result comprises information to help a vendor improve their own ratings, including suggesting secure product development techniques to reduce recurring classes of vulnerabilities, suggesting more efficient product management strategies to improve patch timelines, suggesting how to write missing documentation for specific product categories, suggesting re-phrasing of difficult to understand syntax or semantics in vendor communications, or providing adaptive feedback informed by insights derived from other vendors whose ratings have improved in response to similar recommendations; wherein the adaptive feedback may further refine its recommendations over time through a feedback-loop that analyzes historical correlations between prior feedback actions and subsequent rating improvements.

28. The system according to claim 16, wherein the at least one vendor or product rating result comprises information to inform an end-user's purchase decisions and improve their cybersecurity posture, including examination of a vendor's risk exposure across its entire supply chain network, including original equipment manufacturers (OEMs), component suppliers, and other third-party vendors, comparative ratings of competing vendors, rankings for specific categories of vendors, risk-based approval of vendors, or mapping of vendors to the end-user's specific requirements or compliance and legal requirements.

29. The system according to claim 16, wherein the at least one data sink comprises integrations with a variety of platforms, including third-party software, systems, search engines, browser extensions, online marketplaces and storefronts, as well as Software Bills of Materials (SBOMs), Artificial Intelligence Bills of Materials (AIBOMs), DevSecOps pipelines, Machine Learning Operations (MLOps) pipelines, compliance mapping, API Continuous Integration/Continuous Deployment, displayed on a tablet device, or available from a QR code, barcode, or NFC tag on the vendor's device.

30. The system according to claim 16, wherein displaying comprises at least one of numerical, graphical, textual, or color-coordinated representation of ratings; graphs of how ratings change over time; user interface components displaying vendor ratings and associated information, including logos, categories, and score distributions; wherein the user interface allows for the filtering, sorting, searching, or time-range selection of ratings; and wherein vendor-specific pages display rating explanations, data provenance, and improvement recommendations.
